(19) United States
(12) Patent Application Publication
(10) Pub. No.: US 2019/0241743 A1
(43) Pub. Date: Aug. 8, 2019

(54) BITUMINOUS COMPOSITION FOR HIGH-MODULUS MIXES

(71) Applicant: TOTAL MARKETING SERVICES, Puteaux (FR)

(72) Inventors: Gilles GAUTHIER, Rueil-Malmaison (FR); Mouhamad MOUAZEN, Nanterre (FR)

(73) Assignee: TOTAL MARKETING SERVICES, Puteaux (FR)

(21) Appl. No.: 16/331,803

(22) PCT Filed: Sep. 5, 2017
(86) PCT No.: PCT/FR2017/052345

§ 371 Date: Mar. 8, 2019

(30) Foreign Application Priority Data
Sep. 8, 2016 (FR) 1658334

(51) Int. Cl. C08L 95/00; C08K 3/32; C08K 3/34

(52) U.S. Cl. CPC C08L 95/00; C08K 3/32; C08K 3/34; E01C 7/265; C08L 2555/24; C08K 2003/329; C08L 2555/22

(57) ABSTRACT

A bituminous composition that makes it possible to manufacture high modulus mixes; a high modulus bituminous mix and to the use of these mixes in the preparation of road pavements, in particular in the preparation of base layers or foundation layers for road pavements. A process for transporting and/or storing and/or handling this bituminous composition that is solid at ambient temperature and is in divided form.

### TECHNICAL FIELD

The present invention relates to the field of bitumens. More specifically, the invention relates to a bituminous composition for manufacturing high-modulus surfacing mixes.

The invention also relates to a high-modulus bituminous surfacing mix and to the use of these surfacing mixes in the preparation of roadways, especially in the preparation of base courses or foundation courses for roadways.

The invention also relates to a process for transporting and/or storing and/or handling this bituminous composition which is solid at ambient temperature and in divided form.

### PRIOR ART

Numerous studies have focused on improving the mechanical performance qualities of materials used for the construction of roads in order to increase their resistance to high road stresses.

More particularly, it is known practice to use “hard” or “hard-grade” bitumens, i.e. bitumens which have a penetrability, measured at 25° C. according to the standard EN 1426, of less than 35 1/10 mm, for the manufacture of high-modulus surfacing mixes due to the properties of hard bitumens which intrinsically have a high stiffness modulus, for the purpose of implementation on a road that needs to withstand high road stresses.

In order to increase the hardness of a bitumen, it is known practice to mix a bitumen of defined grade with a bitumen of harder grade than the bitumen of defined grade. However, this process has certain limits: for a significant increase in the hardness of a bitumen, it is necessary to use bitumens of very low penetrability and in large amounts, typically bitumens with a penetrability at 25° C. ranging from 10 to 20 1/10 mm.

However, the supply of hard bitumens is becoming scarce due especially to their very specific manufacturing process which only makes it possible to obtain limited amounts thereof and necessitates the selection of specific crudes.

It is also known practice to add hard bitumen pellets or gilsonite to soft bitumens to increase the hardness thereof. However, the availability of these additives is reduced and does not make it possible to obtain bitumens that have satisfactory properties in terms of modulus.

It is also known practice to modify the properties of a bitumen by applying an oxidizing treatment, such as blowing with air, which increases the hardness of the bitumen. Specifically, blown bitumens, also known as oxidized bitumens, are obtained by blowing a bitumen base with air at temperatures ranging from 240 to 320° C.

EP 1 352 031 teaches a bitumen composition that is suitable for use in road construction, characterized in that the composition has a softening point of from 50 to 75° C. and comprises:

a) a blown bitumen with a penetrability at 25° C. ranging from 10 to 50 1/10 mm, a ring and ball softening point (RBSP) ranging from 70 to 120° C. and a penetration index PI (European standard EN 12591 (1999), appendix B) in the range from 1.0 to 8.5, and

b) a solvent-precipitated asphalt with a penetration at 25° C. ranging from 0 to 40 1/10 mm.

The use of blown bitumens does not by itself allow the manufacture of high-modulus surfacing mixes.

FR 2 153 751 teaches firstly of subjecting the residue from the vacuum distillation of a crude oil to an oxidation treatment and secondly of fractionating the residue from the vacuum distillation of a crude oil, which may or may not be identical to the preceding one, into deasphalted residue and deasphalting bitumen. One part by weight of the oxidized residue is mixed with 0.5 to 2 parts by weight of the deasphalting bitumen thus obtained and, finally, a suitable plasticizer is added to this mixture, so as to adjust the hardness of the bituminous binder to the desired value. However, this method assumes several processing and recomposition operations which must be adapted as a function of the starting crude.

It is also known practice to modify the properties of a bitumen by mixing with other components.

WO 2010/043945 describes a high-modulus bituminous surfacing mix based on recycled road planings comprising residual bituminous binder, new aggregates and added bituminous binder.

However, this composition is obtained after several processing and recomposition operations. Such operations are difficult to perform in certain geographical areas where the installations for recycling road materials are rare or even nonexistent.

WO 2010/086561 describes a bituminous surfacing mix or high-modulus bituminous concrete based on bituminous binder comprising at least one bitumen and at least one natural or synthetic resin and aggregates.

US 2004/0094454 describes petroleum binders comprising a pitch of petroleum origin and a bitumen fraction obtained from a crude oil of petroleum origin.

KR 2004/0001331 describes bituminous compositions whose low-temperature crack strength and flow strength are improved. These bituminous compositions comprise a bitumen base and a pitch of petroleum origin.

However, due to the difficulty associated with the geographic availability and/or the supply of additives such as resin, this type of composition cannot be used at competitive costs in all the areas of distribution in which such compositions are required.

Consequently, there is a need to provide a bituminous composition which has, inter alia, a high modulus meeting the drawbacks of the prior art mentioned above. More particularly, there is a need to provide, in industrial amounts, a high-modulus bituminous composition which is satisfactory for use in the road sector.

Moreover, the increasing scarcity of high-modulus hard bitumens in certain geographic areas has been highlighted, for instance in the African and Middle-Eastern region, since such bitumens are difficult to handle because they need to be heated to high temperature. Consequently, for use in these geographic areas, they must be transported, which can only be done in hot, molten form, which poses ecological, economic and logistical problems.

In general, bitumen is stored and transported hot, in bulk, in tank trucks or by boat at high temperatures of the order of 120° C. to 160° C. However, the storage and transportation of hot bitumen presents certain drawbacks. First, the transportation of hot bitumen in liquid form is considered hazardous and is governed by very strict regulations. This mode of transportation does not present any particular difficulties when the transportation equipment and infrastructures are in good condition. When such is not the case, it may become problematic: if the tank truck is not sufficiently thermally insulated, the viscosity of the bitumen may increase during an excessively long journey. Bitumen delivery distances are therefore limited. Secondly, maintaining bitumen at high temperatures in tanks or in tank trucks consumes energy. In addition, maintaining bitumen at high temperatures for a long period may affect the properties of the bitumen and thus change the final performance qualities of the surfacing mix.

To overcome the problems of transporting and storing hot bitumen, conditionings enabling the transportation and storage of bitumens at ambient temperature have been developed. This mode of transporting bitumen in conditioning at ambient temperature represents only a tiny fraction of the amounts transported worldwide, but it meets very real needs for geographical regions that are difficult and expensive to access via conventional transportation means.

An example that may be mentioned of conditioning for cold transportation that is currently used is the conditioning of bitumen at ambient temperature in metal drums. This means is increasingly coming under question from an environmental viewpoint since the bitumen stored in drums must be heated before its use as road binder. However, this operation is difficult to perform for this type of conditioning, and the drums constitute waste after use. Moreover, the storage of bitumen at ambient temperature in drums leads to losses since bitumen is very viscous and part of the product remains on the walls of the drum during transfer into the tanks of the surfacing-mix production units. As regards the manipulation and transportation of bituminous products in these drums, they may prove to be difficult and hazardous if the specialized equipment for handling drums is not available to transporters or at the site of use of the bitumen.

Other examples of conditioning that may be mentioned include bitumens in the form of pellets transported and/or stored in bags, which are often used in places where the ambient temperature is high. These pellets have the advantage of being easy to handle. U.S. Pat. No. 3,026,568 describes bitumen pellets covered with a powdery material, such as limestone powder. However, this type of granular bitumen does not prevent the bitumen from undergoing creep, especially at elevated ambient temperature.

As other examples of conditioning, mention may be made of bituminous compositions comprising a chemical additive in the form of blocks or pellets described in WO 2016/016318 and in WO 2016/016320, allowing bitumen to be transported and/or stored and/or handled at ambient temperature.

Nevertheless, depending on the bitumen grades used, either the modulus properties of some of these compositions are not sufficiently satisfactory for use on a road which needs to withstand very high road stresses, or it becomes difficult to obtain industrial amounts of hard-grade bitumens for obtaining high-modulus surfacing mixes.

There is also a need to provide a bituminous composition having, inter alia, a high modulus, the transportation and/or storage and/or handling of which is simplified irrespective of the geographic area of its use, when compared with the bituminous compositions described in the prior art.

The Applicant has observed that the addition of a particular pitch to a bitumen makes it possible to obtain industrial amounts of hard bitumens which have very satisfactory modulus properties, making it possible satisfactorily to solve the problems mentioned above.

More particularly, the Applicant has demonstrated that such compositions with very satisfactory modulus properties could be readily available in industrial amounts and in a form allowing them to be transported, stored and handled at ambient temperature, even at elevated ambient temperature. In this case, the bituminous composition proposed is in divided and solid form at ambient temperature, and as such it satisfactorily solves the problems mentioned above.

### SUMMARY OF THE INVENTION

The invention relates to a bituminous composition, characterized in that the composition comprises:

a) at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, and

b) at least one bitumen base.

According to a preferred embodiment, the pitch is an oxidized pitch.

According to a preferred embodiment, the pitch is present in an amount ranging from 2% to 30% by mass relative to the total mass of the composition.

According to a preferred embodiment, the bituminous composition according to the invention is in solid form under cold conditions and in a divided form.

According to a more preferred embodiment, the bituminous composition is solid under cold conditions and in divided form, and also comprises at least one chemical additive chosen from an organic compound, a paraffin, a polyphosphoric acid, and mixtures thereof.

According to a preferred embodiment of the invention, the bituminous composition comprises from 0.1% to 5% by mass, preferably from 0.5% to 4% by mass, more preferentially from 0.5% to 2.8% by mass and even more preferentially from 0.5% to 2.5% by mass of said chemical additive relative to the total mass of said bitumen base.

According to a preferred embodiment, the chemical additive is an organic compound which has a molar mass of less than or equal to 2000 g·mol⁻¹, preferably a molar mass of less than or equal to 1000 g·mol⁻¹.

According to a preferred embodiment, the bituminous composition is in the form of a block or pellets.

The invention also relates to a process for manufacturing a bituminous composition, this process comprising the following steps:
heating the bitumen base b) to a temperature ranging from 140 to 180° C.,
introducing pitch a) into the bitumen base b),
stirring the mixture at a temperature ranging from 140 to 180° C. until a homogeneous mixture is obtained.

According to a preferred embodiment of the process, the pitch is introduced in the form of pellets.

The invention also relates to a kit which may be used for the manufacture of a bituminous composition as defined above, this kit comprising at least:
a bitumen base which is solid under cold conditions and in divided form,
a capsule comprising at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, in the form of pellets.

According to a preferred embodiment of the kit, the bitumen base which is solid under cold conditions and in divided form is in block form.

According to a preferred embodiment of the kit, the bitumen base which is solid under cold conditions and in divided form comprises, on one of its faces, a cavity for housing all or part of the capsule.

According to a preferred embodiment of the kit, the capsule is removably housed totally or partly in said cavity.

A subject of the invention is also a process for preparing a bituminous composition which is solid under cold conditions and in divided form, comprising at least one bituminous composition and at least one chemical additive chosen from an organic compound, a paraffin, a polyphosphoric acid, and mixtures thereof, the process comprising:
the mixing of at least one bituminous composition and of at least one chemical additive chosen from an organic compound, a paraffin, a polyphosphoric acid, and mixtures thereof, to form a supplemented bituminous composition,
the forming of the supplemented bituminous composition in the form of a block or pellets.

A subject of the invention is also a process for transporting and/or storing and/or handling the bituminous composition which is solid under cold conditions and in divided form, said bituminous composition being transported and/or stored and/or handled in the form of blocks or pellets of bituminous composition which are solid at ambient temperature.

The invention also relates to the use of the bituminous composition described above and in detail below, for the manufacture of bituminous surfacing mixes or bituminous concretes.

A subject of the invention is also bituminous surfacing mixes or concretes comprising the bituminous composition described above and in detail below, and aggregates.

The invention also relates to a process for manufacturing bituminous surfacing mixes or bituminous concretes comprising at least one bituminous composition and aggregates, the bituminous composition being chosen from bituminous compositions which are solid under cold conditions and in divided form, this process comprising at least the steps of:
heating the aggregates to a temperature ranging from 100° C. to 180° C.,
mixing the aggregates with the bituminous composition which is solid under cold conditions and in divided form in a tank such as a mixer or a mixing drum,
obtaining surfacing mixes.

According to a preferred embodiment, this process does not include a step of heating the bituminous composition which is solid under cold conditions and in divided form, before it is mixed with the aggregates.

The invention also relates to the use of a pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, for increasing the modulus of a bituminous composition.

### DETAILED DESCRIPTION

The objectives that the Applicant set itself have been achieved by means of the development of bitumen compositions comprising a particular pitch making it possible to achieve satisfactory properties for bituminous compositions intended to be used for road applications, especially an improved modulus relative to the bituminous compositions known in the prior art.

They were also achieved by means of the use of these bituminous compositions in a divided form which is solid at ambient temperature, giving said compositions improved properties, especially in terms of modulus, thus making it possible to transport and/or store and/or handle them more easily when compared with the bitumen compositions known in the prior art.

A first subject of the invention relates to a bituminous composition comprising: a) at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, and b) at least one bitumen base.

The invention also relates to a process for manufacturing a bitumen composition as described above and in greater detail below, this process comprising the following steps:
heating the bitumen base b) to a temperature ranging from 140 to 180° C.,
introducing pitch a) into the bitumen base b),
stirring the mixture at a temperature ranging from 140 to 180° C. until a homogeneous mixture is obtained.

The expression “between X and Y” includes the limits. This expression thus means that the targeted range comprises the values X, Y and all the values ranging from X to Y.

The term “bitumen” means any bituminous composition constituted by one or more bitumen bases, said composition being intended for a road application.

According to the present invention, the term “pitch” means a petroleum distillation residue.

According to the invention, the bitumen base is chemically different from the pitch used. Consequently, the bitumen base and the pitch cannot be used as replacement for each other since their chemical characteristics are different.

The term “penetrability” means here the “needle penetrability” measurement, which is performed by means of an NF EN 1426 standardized test at 25° C. (P25). This penetrability characteristic is expressed in tenths of a millimeter (dmm or 1/10 mm). The needle penetrability, measured at 25° C. according to the standardized test NF EN 1426, represents the measurement of the penetration into a bitumen sample, after a time of 5 seconds, of a needle whose weight with its support is 100 g. The standard NF EN 1426 replaces the endorsed standard NF T 66-004 of December 1986 with effect from Dec. 20, 1999 (decision of the Director General of AFNOR dated Nov. 20, 1999).

The term “softening point” means the “ring and ball softening point” measurement which is performed by means of the standardized test NF EN 1427. The ring and ball softening point corresponds to the temperature at which a steel ball of standard diameter, after having passed through the test material (stuck in a ring), reaches the bottom of a standardized vessel filled with a liquid which is gradually heated and into which the apparatus has been immersed.

The term “modulus” means the measurement defining the ratio of the stress amplitude to the strain amplitude in harmonic sinusoidal oscillation, which is performed by means of a standardized test NF EN 14770. The modulus of the bituminous composition, also known as the complex modulus or the stiffness modulus of the bituminous composition, is determined using a dynamic shear rheometer. To do this, a series of sinusoidal strains of defined frequencies are applied to the sample maintained at a defined temperature. According to the standard NF EN 14770, the complex modulus of the bituminous composition is determined for a sinusoidal strain with a frequency of between 0.1 and 10 Hz at a temperature ranging from 5 to 85° C. In the invention, the complex modulus of the bituminous composition was determined for a sinusoidal strain with a frequency of 10 Hz at a temperature of 15° C. and also at a temperature of 60° C. To determine the modulus of the bituminous composition, the bituminous composition is placed between two parallel plates, one being immobile, the other mobile. The upper assembly imposes the shear strain, and the resulting shear is recorded.

The term “modulus of the surfacing mixes” means the measurement of the complex stiffness modulus of the bituminous surfacing mixes according to the standard NF EN 13108-1. In the invention, the complex modulus of the bituminous surfacing mixes was determined for a sinusoidal stress with a frequency of 10 Hz at a temperature of 15° C.

According to one embodiment of the invention, the pitch is in the form of pellets before it is introduced into the heated bitumen base. Such an embodiment facilitates the handling of the components and the implementation of the process.

According to one embodiment of the invention, the pitch is a blown pitch. For the purposes of the invention, use will be made, independently of each other, of the terms “blown pitch” and “oxidized pitch”.

According to one embodiment of the invention, the bituminous composition comprises from 2% to 30% by mass of pitch, relative to the total mass of the composition, preferably from 3% to 20% by mass of pitch relative to the total mass of the composition.

The term “consists essentially of” or “is constituted essentially of” followed by one or more features means that, besides the components or steps specifically listed, components or steps which do not significantly modify the properties and features of the invention may be included in the process or the material of the invention.

Pitch

According to the dictionary, the term “pitch” means a residue from the distillation of tars from oil, from coal, from wood or from other organic molecules.

The invention relates herein to the residues from the distillation of oil, also known as “petroleum pitch”.

For the purposes of the invention, use will be made, independently of each other, of the terms “pitch”, “petroleum pitch” and “deasphalting pitch”.

The pitches may be obtained via conventional manufacturing processes in a refinery. The manufacturing process corresponds to the sequence of atmospheric distillation and vacuum distillation. In a first stage, crude oil is subjected to distillation at atmospheric pressure, which leads to the production of a gaseous phase, of various distillates and of an atmospheric distillation residue. The residue from the atmospheric distillation is then itself subjected to a distillation under reduced pressure, known as vacuum distillation, which makes it possible to separate a heavy gas oil, various distillate fractions and a vacuum distillation residue. This vacuum distillation residue contains “petroleum pitch” in variable concentration.

It is possible to obtain “petroleum pitch” according to two processes:

### 1st Process:

The vacuum distillation residue is subjected to a deasphalting operation by addition of an appropriate solvent, such as propane, which thus makes it possible to precipitate the pitch and to separate it from the light fractions, such as the deasphalted oil.

### 2nd Process:

The vacuum distillation residue is subjected to solvent extraction, more specifically with furfural. This heterocyclic aldehyde has the distinguishing feature of selectively dissolving aromatic and polycyclic compounds. This process thus makes it possible to remove the aromatic extracts and to recover the “petroleum pitch”.

According to one embodiment, the pitch is an oxidized pitch.

Preferably, the oxidized pitch used according to the invention is obtained by oxidation of a mixture comprising pitch and a diluent, such as a light gasoline, also known as “flux”, subjected to an oxidation operation in a blowing tower in the presence of a catalyst, at a fixed temperature and at a given pressure.

For example, oxidized pitches may be manufactured in a blowing unit by passing a stream of air and/or oxygen through a starting pitch. This operation may be performed in the presence of an oxidation catalyst, for example phosphoric acid. The oxidation is generally performed at high temperatures, of the order of 200 to 300° C., for relatively long periods typically between 30 minutes and 2 hours, continuously or in batches. The oxidation time and temperature are adjusted as a function of the properties targeted for the oxidized pitch and as a function of the quality of the starting pitch.

The mechanical qualities of the pitches are generally evaluated by determining a series of mechanical features via standardized tests, the most widely used of which are the needle penetrability expressed in 1/10 mm and the softening point determined by the ring and ball test, also known as the ring and ball softening point (RBSP).

According to one embodiment of the invention, the pitch has a needle penetrability at 25° C. of from 0 to 20 1/10 mm, preferably from 0 to 15 1/10 mm, more preferably from 0 to 10 1/10 mm, it being understood that the penetrability is measured according to the standard EN 1426.

According to one embodiment of the invention, the pitch has a softening point of between 115° C. and 175° C. Among examples of pitches used in the invention, there are pitches respectively having a softening point of between 115° C. and 125° C., between 135° C. and 145° C. or between 165° C. and 175° C.

The addition of a pitch with the mechanical characteristics presented above to a bituminous composition makes it possible to improve the modulus properties of said bituminous composition and also to improve the modulus properties of the bituminous surfacing mixes. Furthermore, the addition of the pitch according to the invention to a bituminous composition makes it possible to reduce the penetrability and to increase the ring and ball softening point of said bituminous composition while maintaining the viscosity of said bituminous composition, in comparison with a pitch-free bituminous composition.

According to one embodiment of the invention, the pitch is solid under cold conditions and in divided form. This form facilitates the handling of the pitch for the use thereof in the manufacture of the bituminous composition.

The term “pitch which is solid under cold conditions and in divided form” means a pitch which is solid at ambient temperature and which is packaged in a divided form, i.e. in the form of units which are distinct from one another, for example pellets.

According to one embodiment of the invention, the pitch which is solid under cold conditions is in the form of pellets.

The pitch pellets according to the invention may have, within the same population of pellets, one or more shapes chosen from a cylindrical, spherical or oval shape. More specifically, the pitch pellets according to the invention preferably have a cylindrical or spherical shape.

According to one embodiment of the invention, the size of the pitch pellets is such that the longest mean dimension is preferably less than or equal to 50 mm, more preferentially from 2 to 30 mm. For example, the use of a die makes it possible to control the manufacture of pellets of a chosen size. Screening makes it possible to select pellets as a function of their size.

To allow the formation of pitch pellets which do not adhere together and which withstand compression during their storage, it may be advantageous to coat all or part of the surface of the pitch pellets with an anticaking agent.

The pitch, in the form of pellets optionally covered with an anticaking compound, can be easily handled after a prolonged period of transportation and/or storage.

### Process for Manufacturing a Bituminous Composition:

A subject of the invention is also a process for manufacturing a bituminous composition comprising at least one pitch a) and at least one bituminous base b), as have been defined above, this process comprising at least the steps of:
heating the bitumen base b) to a temperature ranging from 140 to 180° C.,
introducing pitch a) into the bitumen base b),
stirring the mixture at a temperature ranging from 140 to 180° C. until a homogeneous mixture is obtained.

It was found, surprisingly, that the pitch mixes perfectly with the bitumen base.

Advantageously, the pitch does not need to be heated, before being added to the bitumen base.

Although the pitch usually has a melting point of greater than 220° C., it dissolves in the bitumens at the normal temperatures for the preparation of the bituminous compositions. On the other hand, soft bitumens must be heated beforehand in order to be incorporated into a bituminous composition.

The process for manufacturing the bituminous composition is easy to perform and does not require transportation under hot conditions over long distances of the pitch intended to improve the properties of the bitumen base, unlike the bitumen bases of “hard” grade used in the prior art.

Advantageously, a bitumen base produced in the application zone may be used and its properties improved by the addition of pitch.

Bituminous Composition which is Solid Under Cold Conditions and in Divided Form

The bituminous composition according to the invention may be in solid form under cold conditions and in a divided form.

The term “bitumen which is solid under cold conditions” means a bitumen which has a solid appearance at ambient temperature, irrespective of the transportation and/or storage conditions. More precisely, the term “bitumen which is solid at ambient temperature” means a bitumen which conserves its solid appearance throughout the transportation and/or storage at ambient temperature, i.e. a bitumen which does not undergo creep at ambient temperature under its own weight and, moreover, which does not undergo creep when it is subjected to pressure forces arising from the transportation and/or storage conditions.

According to one embodiment, the bituminous composition which is solid under cold conditions and in divided form comprises:

a) at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427,

b) at least one bitumen base, and

c) at least one chemical additive.

For the purposes of the invention, the bituminous composition which is solid under cold conditions and in divided form is also referred to as a “supplemented bituminous composition”.

According to one embodiment, the bituminous composition according to the invention which is solid under cold conditions and in divided form comprises at least one chemical additive chosen from: an organic compound, a paraffin, a polyphosphoric acid, and mixtures thereof.

In particular, the bituminous composition which is solid and in divided form comprises at least one chemical additive in a suitable amount so that its penetrability is preferably from 5 to 70 1/10 mm, preferably from 10 to 60 1/10 mm, it being understood that the penetrability is measured at 25° C. according to the standard EN 1426.

Another subject relates to the use of a pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, for increasing the modulus of a bituminous composition.

Bitumen Base

For the purposes of the invention, the terms “bitumen” and “road bitumen” are used equivalently and independently of each other. The term “bitumen” or “road bitumen” means any bituminous composition constituted by one or more bitumen bases and optionally comprising one or more chemical additives and/or one or more elastomers, said compositions being intended for a road application.

Among the bitumen bases that may be used according to the invention, mention may be made first of bitumens of natural origin, those contained in deposits of natural bitumen, of natural asphalt or bituminous sands and bitumens originating from the refining of crude oil. The bitumen bases according to the invention are advantageously chosen from bitumen bases originating from the refining of crude oil. The bitumen bases may be chosen from bitumen bases or mixtures of bitumen bases originating from the refining of crude oil, in particular bitumen bases containing asphaltenes.

The bitumen bases may be obtained via conventional processes for manufacturing bitumen bases at a refinery, in particular by direct distillation and/or vacuum distillation of oil. These bitumen bases may optionally be viscosity-reduced and/or de-asphalted and/or air-rectified. It is common practice to perform vacuum distillation on the atmospheric residues originating from the atmospheric distillation of crude oil. This manufacturing process consequently corresponds to the sequence of atmospheric distillation and vacuum distillation, the feedstock feeding the vacuum distillation corresponding to the atmospheric residues. These vacuum residues derived from the vacuum distillation tower may also be used as bitumens. It is also common practice to inject air into a feedstock usually composed of distillates and of heavy products originating from the vacuum distillation of atmospheric residues originating from oil distillation. This process makes it possible to obtain a blown or semi-blown or air-oxidized or air-rectified or partially air-rectified base.

The various bitumen bases obtained via the refining processes may be combined together to obtain the best technical compromise. The bitumen base may also be a recycled bitumen base. The bitumen bases may be bitumen bases of hard grade or of soft grade.

According to the invention, for the conventional processes for manufacturing bitumen bases, the process is performed at manufacturing temperatures of between 100° C. and 200° C., preferably between 140° C. and 200° C., more preferentially between 140° C. and 170° C., and with stirring for a time of at least 10 minutes, preferably between 30 minutes and 10 hours, more preferentially between 1 hour and 6 hours. The term “manufacturing temperature” means the temperature of heating of the bitumen base(s) before mixing and also the mixing temperature. The heating time and temperature vary according to the amount of bitumen used and are defined by the standard NF EN 12594.

Preferentially, the bitumen base used in the invention has a needle penetrability measured at 25° C. according to the standard EN 1426 of from 30 to 330 1/10 mm, preferably from 30 to 220 1/10 mm.

According to one embodiment of the invention, the bitumen base may also comprise at least one known bitumen elastomer such as SB copolymers (copolymer containing styrene and butadiene blocks), SBS copolymers (copolymer containing styrene-butadiene-styrene blocks), SIS (styrene-isoprene-styrene) copolymers, SBS* copolymers (copolymer containing styrene-butadiene-styrene star blocks), SBR (styrene-b-butadiene-rubber) copolymers and EPDM (ethylene propylene diene modified) copolymers. These elastomers may also be crosslinked according to any known process, for example with sulfur. Mention may also be made of elastomers prepared from styrene monomers and butadiene monomers allowing crosslinking without a crosslinking agent, as described in WO 2007/058994 and WO 2008/137394 and by the Applicant in patent application WO 11/013073.

Preferably, the bituminous composition comprises from 70% to 99.9% by mass of bitumen base, relative to the total mass of the bituminous composition, preferably from 75% to 99.5% and even more preferentially from 80% to 99%.

According to one embodiment of the invention, the bituminous composition comprises from 0.5% to 15% by mass, preferably from 1% to 15% by mass and more preferentially from 2% to 12% by mass of elastomer relative to the total mass of the bituminous composition.

Additive

The chemical additive is chosen from: an organic compound, a paraffin, a polyphosphoric acid, and mixtures thereof.

In one embodiment of the invention, the chemical additive is an organic compound. Advantageously, the organic compound has a molar mass of less than or equal to 2000 g·mol⁻¹, preferably a molar mass of less than or equal to 1000 g·mol⁻¹.

In this first embodiment, according to a first variant, the organic compound is a compound of general formula (I):

Ar1-R-Ar2 (I),

in which:
Ar1 and Ar2 represent, independently of each other, a benzene nucleus or a system of fused aromatic nuclei of 6 to 20 carbon atoms, substituted with at least one hydroxyl group, and
R represents an optionally substituted divalent radical, the main chain of which comprises from 6 to 20 carbon atoms and at least one group chosen from amide, ester, hydrazide, urea, carbamate and anhydride functions.

Preferably, Ar1 and/or Ar2 are substituted with at least one alkyl group of 1 to 10 carbon atoms, advantageously in one or more ortho positions relative to the hydroxyl group(s); more preferentially, Ar1 and Ar2 are 3,5-dialkyl-4-hydroxyphenyl groups, advantageously 3,5-di-tert-butyl-4-hydroxyphenyl groups.

Preferably, R is in the para position relative to a hydroxyl group of Ar1 and/or Ar2.

Advantageously, the compound of formula (I) is 2′,3-bis[(3-[3,5-di-tert-butyl-4-hydroxyphenyl]propionyl)]propionohydrazide.

According to a second variant of this first embodiment, the organic compound is a compound of general formula (II):

R—(NH)ₘCONH—(X)ₘ—NHCO(NH)ₙ—R′ (II),

in which:
the groups R and R′, which may be identical or different, contain a saturated or unsaturated, linear, branched or cyclic hydrocarbon-based chain, comprising from 1 to 22 carbon atoms, which is optionally substituted, and optionally comprising heteroatoms, rings and/or heterocycles;
the group X contains a saturated or unsaturated, linear, branched or cyclic hydrocarbon-based chain, comprising from 1 to 22 carbon atoms, which is optionally substituted, and optionally comprising heteroatoms, rings and/or heterocycles;
n and m are integers having a value of 0 or 1, independently of each other.

According to this variant, when the integer m has a value of 0, then the groups R—(NH)ₙCONH and NHCO(NH)ₙ—R′ are covalently bonded via a hydrazide bond CONH—NHCO. The group R, or the group R′, then comprises at least one group chosen from: a hydrocarbon-based chain of at least 4 carbon atoms, an aliphatic ring of 3 to 8 atoms, an aliphatic, partially aromatic or totally aromatic fused polycyclic system, each ring comprising 5 or 6 atoms.

Still according to this variant, when the integer m has a value of 1, then the group R, the group R′ and/or the group X comprises at least one group chosen from: a hydrocarbon-based chain of at least 4 carbon atoms, an aliphatic ring of 3 to 8 atoms, an aliphatic, partially aromatic or totally aromatic fused polycyclic system, each ring comprising 5 or 6 atoms.

Preferably, the group R and/or R′ comprises an aliphatic hydrocarbon-based chain of 4 to 22 carbon atoms, chosen especially from C₄H₉, C₅H₁₁, C₉H₁₉, C₁₁H₂₃, C₁₂H₂₅, C₁₇H₃₅, C₁₈H₃₇, C₂₁H₄₃ and C₂₂H₄₅ groups.

Preferably, the group X represents a linear saturated hydrocarbon-based chain comprising from 1 to 22 carbon atoms. Preferably, the group X is chosen from C₂H₄ and C₃H₆ groups.

Preferably, the group X may also be a cyclohexyl group or a phenyl group, and the radicals R—(NH)ₙCONH— and NHCO(NH)ₙ—R′— may then be in the ortho, meta or para position. Moreover, the radicals R—(NH)ₙCONH— and NHCO(NH)ₙ—R′— may be in the cis or trans position relative to each other. Furthermore, when the radical X is cyclic, this ring may be substituted with groups other than the two main groups R—(NH)ₙCONH— and —NHCO(NH)ₙ—R′.

Preferably, the group X comprises two rings of 6 carbons bonded via a CH₂ group, these rings being aliphatic or aromatic. In this case, the group X is a group including two aliphatic rings bonded via an optionally substituted CH₂ group, for instance:

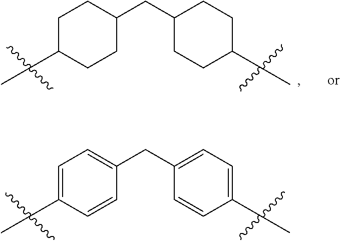 [SMILES: *C1CCC(CC2CCC(*)CC2)CC1 ; *c1ccc(Cc2ccc(*)cc2)cc1]

Advantageously, according to this variant, the organic compound is a compound of general formula (II) chosen from hydrazide derivatives such as the compounds C₅H₁₁—CONH—NHCO—C₅H₁₁, C₉H₁₉—CONH—NHCO—C₉H₁₉, H₂₃—CONH—NHCO—C₁₁H₂₃, C₁₇H₃₅—CONH—NHCO—C₁₇H₃₅, or C₂₁H₄₃—CONH—NHCO—C₂₁H₄₃; diamides such as N,N′-ethylenedi(stearamide) of formula C₁₇H₃₅—CONH—CH₂—CH₂—NHCO—C₁₇H₃₅; and ureide derivatives such as 4,4′-bis(dodecylaminocarbonylamino)-diphenylmethane of formula C₁₂H₂₅—NHCONH—C₆H₄—CH₂—C₆H₄—NHCONH—C₁₂H₂₅.

Preferably, the compound of general formula (II) is chosen from those which satisfy the condition n=0.

Preferably, the compound of general formula (II) is chosen from those which satisfy the condition: the sum of the numbers of carbon atoms of R, X and R′ is greater than or equal to 10, advantageously greater than or equal to 14, preferably greater than or equal to 18.

Preferably, the compound of general formula (II) is chosen from those which satisfy the condition: the number of carbon atoms of at least one from among R and R′ is greater than or equal to 10, advantageously greater than or equal to 12, preferably greater than or equal to 14.

Preferably, according to a first variant, the compound of general formula (II) is chosen from those of formula (IIA):

R—CONH—(X)ₘ—NHCO—R′ (IIA)

in which R, R′, m and X have the same definition as above.

Preferably, in formula (IIA), when m=1, the X group represents a saturated linear hydrocarbon-based chain comprising from 1 to 22 carbon atoms; advantageously, X represents a saturated linear hydrocarbon-based chain comprising from 1 to 12 carbon atoms and better still from 1 to 4 carbon atoms. Preferably, the group X is chosen from C₂H₄ and C₃H₆ groups.

Preferably, the compound of general formula (IIA) is chosen from those which satisfy the condition: the sum of the numbers of carbon atoms of R, X and R′ is greater than or equal to 10, advantageously greater than or equal to 14, preferably greater than or equal to 18.

Preferably, the compound of general formula (IIA) is chosen from those which satisfy the condition: the number of carbon atoms of at least one from among R and R′ is greater than or equal to 10, advantageously greater than or equal to 12, preferably greater than or equal to 14.

More preferentially, according to this variant, the compound of general formula (IIA) is chosen from hydrazide derivatives, such as the compounds C₅H₁₁—CONH—NHCO—C₅H₁₁, C₉H₁₉—CONH—NHCO—C₉H₁₉, C₁₁H₂₃—CONH—NHCO—C₁₁H₂₃, C₁₇H₃₅—CONH—NHCO—C₁₇H₃₅ or C₂₁H₄₃—CONH—NHCO—C₂₁H₄₃; diamides, such as N,N′-ethylenedi(laurylamide) of formula C₁₁H₂₃—CONH—CH₂—CH₂—NHCO—C₁₁H₃₁, N,N′-ethylenedi(myristylamide) of formula C₁₃H₂₇—CONH—CH₂—CH₂—NHCO—C₁₃H₂₇, N,N′-ethylenedi(palmitamide) of formula C₁₅H₃₁—CONH—CH₂—CH₂—NHCO—C₁₅H₃₁ or N,N′-ethylenedi(stearamide) of formula C₁₇H₃₅—CONH—CH₂—CH₂—NHCO—C₁₇H₃₅; monoamides, such as laurylamide of formula C₁₁H₂₃—CONH₂, myristylamide of formula C₁₃H₂₇—CONH₂, palmitamide of formula C₁₅H₃₁—CONH₂ or stearamide of formula C₁₇H₃₅—CONH₂.

Even more advantageously, the compound of general formula (IIA) is N,N′-ethylenedi(stearamide) of formula C₁₇H₃₅—CONH—CH₂—CH₂—NHCO—C₁₇H₃₅.

Preferably, according to a second variant, the compound of general formula (II) is chosen from those of formula (IIB):

R—CONH—R′ (IIB)

in which R and R′ have the same definition as above.

Advantageously, according to this variant, the sum of the numbers of carbon atoms of R and R′ is greater than or equal to 10, advantageously greater than or equal to 14, preferably greater than or equal to 18.

Even more advantageously, according to this variant, the number of carbon atoms of R is greater than or equal to 10, advantageously greater than or equal to 12, preferably greater than or equal to 14, and R′═H.

Advantageously, the compound of general formula (II) is chosen from hydrazide derivatives, such as the compounds C₅H₁₁—CONH—NHCO—C₅H₁₁, C₉H₁₉—CONH—NHCO—C₉H₁₉, C₁₁H₂₃—CONH—NHCO—C₁₁H₂₃, C₁₇H₃₅—CONH—NHCO—C₁₇H₃₅ or C₂₁H₄₃—CONH—NHCO—C₂₁H₄₃; diamides, such as N,N′-ethylenedi(laurylamide) of formula C₁₁H₂₃—CONH—CH₂—CH₂—NHCO—C₁₁H₃₁, N,N′-ethylenedi(myristylamide) of formula C₁₃H₂₇—CONH—CH₂—CH₂—NHCO—C₁₃H₂₇, N,N′-ethylenedi(palmitamide) of formula C₁₅H₃₁—CONH—CH₂—CH₂—NHCO—C₁₅H₃₁ or N,N′-ethylenedi(stearamide) of formula C₁₇H₃₅—CONH—CH₂—CH₂—NHCO—C₁₇H₃₅; monoamides, such as laurylamide of formula C₁₁H₂₃—CONH₂, myristylamide of formula C₁₃H₂₇—CONH₂, palmitamide of formula C₁₅H₃₁—CONH₂ or stearamide of formula C₁₇H₃₅—CONH₂.

Even more advantageously, the compound of general formula (II) is N,N′-ethylenedi(stearamide) of formula C₁₇H₃₅—CONH—CH₂—CH₂—NHCO—C₁₇H₃₅.

Preferably, when the chemical additive is chosen from the organic compounds of formula (II), it is used in combination with at least one other chemical additive chosen from the organic compounds of formulae (I), (III), (V), (VI) and (VII) and the reaction products of at least one C₃-C₁₂ polyol and of at least one C₂-C₁₂ aldehyde, in particular those comprising a group of formula (IV).

According to a third variant of this embodiment, the organic compound is a compound of formula (III):

(R—NHCO)ₓ—Z—(NHCO—R′)_{y} (III),

in which:
R and R′, which may be identical or different, contain a saturated or unsaturated, linear, branched or cyclic hydrocarbon-based chain, comprising from 1 to 22 carbon atoms, which is optionally substituted, and optionally comprising heteroatoms, rings and/or heterocycles,
Z represents a trifunctionalized group chosen from the following groups:

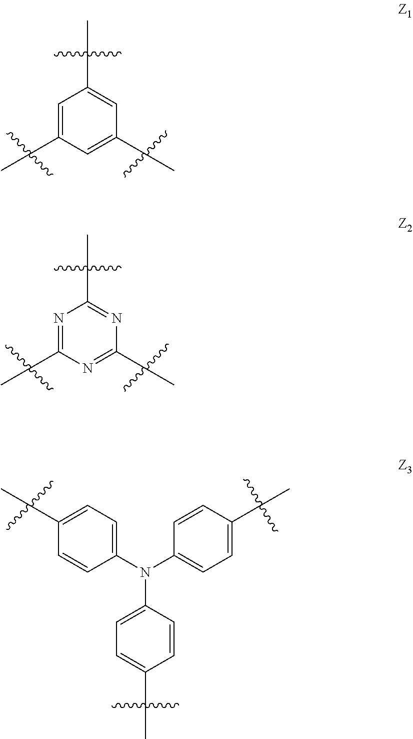 [SMILES: *c1cc(*)cc(*)c1 ; *c1nc(*)nc(*)n1 ; *c1ccc(N(c2ccc(*)cc2)c2ccc(*)cc2)cc1]

x and y are different integers with a value ranging from 0 to 3, and such that x+y=3.

Preferably, when x is equal to 0 and Z represents Z₂, the compound of formula (III) is N2,N4,N6-tridecylmelamine having the following formula with R′ representing the C₉H₁₉ group:

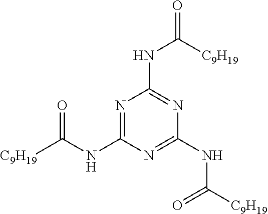

Other preferred compounds corresponding to formula (III) are such that x is equal to 0, Z represents Z₂ and R′ represents a saturated linear hydrocarbon-based chain of 1 to 22 carbon atoms, preferably of 2 to 18 carbon atoms, preferably of 5 to 12 carbon atoms.

Other preferred compounds corresponding to formula (III) are such that: y is equal to 0 and Z represents Z₁, the compounds then having the formula:

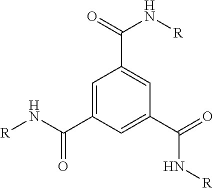

with R chosen from the following groups, taken alone or as mixtures:

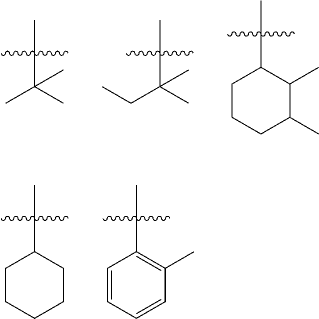

Other preferred compounds corresponding to formula (III) are such that: y is equal to 0, Z represents Z₁ and R represents a saturated linear hydrocarbon-based chain of 1 to 22 carbon atoms, preferably of 8 to 12 carbon atoms.

According to a fourth variant of this embodiment, the organic compound is a reaction product of at least one C₃-C₁₂ polyol and of at least one C₂-C₁₂ aldehyde. Among the polyols that may be used, mention may be made of sorbitol, xylitol, mannitol and/or ribitol. Preferably, the polyol is sorbitol.

Advantageously, according to this variant, the organic compound is a compound which comprises at least one function of general formula (IV):

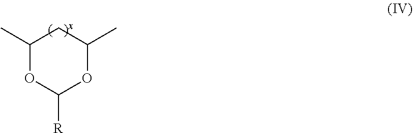

with:
x is an integer,
R is chosen from a C₁-C₁₁ alkyl, alkenyl, aryl or aralkyl radical, optionally substituted with one or more halogen atoms or one or more C₁-C₆ alkoxy groups.

The organic compound is advantageously a sorbitol derivative. The term “sorbitol derivative” means any reaction product obtained from sorbitol, in particular any reaction product obtained by reacting an aldehyde with D-sorbitol. Sorbitol acetals, which are sorbitol derivatives, are obtained via this condensation reaction. 1,3:2,4-Di-O-benzylidene-D-sorbitol is obtained by reacting 1 mol of D-sorbitol and 2 mol of benzaldehyde and has the formula:

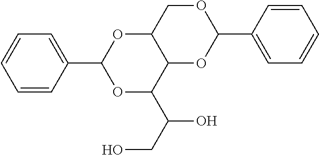 [SMILES: OCC(O)C1OC(c2ccccc2)OC2COC(c3ccccc3)OC21]

The sorbitol derivatives may thus all be condensation products of aldehydes, especially of aromatic aldehydes, with sorbitol. Sorbitol derivatives having the general formula below will then be obtained:

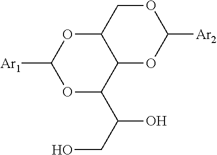

in which Ar₁ and Ar₂ are optionally substituted aromatic nuclei.

Among the sorbitol derivatives, other than 1,3:2,4-di-O-benzylidene-D-sorbitol, are, for example, 1,3:2,4:5,6-tri-O-benzylidene-D-sorbitol, 2,4-mono-O-benzylidene-D-sorbitol, 1,3:2,4-bis(p-methylbenzylidene)sorbitol, 1,3:2,4-bis(3,4-dimethylbenzylidene)sorbitol, 1,3:2,4-bis(p-ethylbenzylidene)sorbitol, 1,3:2,4-bis(p-propylbenzylidene)sorbitol, 1,3:2,4-bis(p-butylbenzylidene)sorbitol, 1,3:2,4-bis(p-ethoxylbenzylidene)sorbitol, 1,3:2,4-bis(p-chlorobenzylidene)sorbitol, 1,3:2,4-bis(p-bromobenzylidene)sorbitol, 1,3:2,4-di-O-methylbenzylidene-D-sorbitol, 1,3:2,4-di-O-dimethylbenzylidene-D-sorbitol, 1,3:2,4-di-O-(4-methylbenzylidene)-D-sorbitol and 1,3:2,4-di-O-(4,3-dimethylbenzylidene)-D-sorbitol. Preferably, according to this variant, the organic compound is 1,3:2,4-di-O-benzylidene-D-sorbitol.

According to a fifth variant of this embodiment, the organic compound is a compound of general formula (V):

R″—(COOH)_{z} (V),

in which R″ represents a linear or branched, saturated or unsaturated chain comprising from 4 to 68 carbon atoms, preferably from 4 to 54 carbon atoms, more preferentially from 4 to 36 carbon atoms and z is an integer ranging from 2 to 4.

Preferably, the group R″ is a saturated linear chain of formula C_{w}H_{2w} with w being an integer ranging from 4 to 22, preferably from 4 to 12.

According to this variant of the invention, the organic compounds corresponding to formula (V) may be diacids (z=2), triacids (z=3) or tetracids (z=4). The preferred organic compounds according to this variant are diacids with z=2.

Preferably, according to this variant, the diacids have the general formula HOOC—C_{w}H_{2w}—COOH with w being an integer ranging from 4 to 22, preferably from 4 to 12 and in which z=2 and R″═C_{w}H_{2w}.

Advantageously, according to this variant, the organic compound is a diacid chosen from adipic acid or 1,6-hexanedioic acid with w=4, pimelic acid or 1,7-heptanedioic acid with w=5, suberic acid or 1,8-octanedioic acid with w=6, azelaic acid or 1,9-nonanedioic acid with w=7, sebacic acid or 1,10-decanedioic acid with w=8, undecanedioic acid with w=9, 1,2-dodecanedioic acid with w=10 or tetradecanedioic acid with w=12.

More advantageously, the organic compound is sebacic acid or 1,10-decanedioic acid with w=8.

The diacids may also be diacid dimers of unsaturated fatty acid(s), i.e. dimers formed from at least one unsaturated fatty acid, for example from a single unsaturated fatty acid or from two different unsaturated fatty acids. Diacid dimers of unsaturated fatty acid(s) are conventionally obtained by intermolecular dimerization reaction of at least one unsaturated fatty acid (for example Diels-Alder reaction).

Preferably, only one type of unsaturated fatty acid is dimerized. They are derived in particular from the dimerization of an unsaturated fatty acid especially of C₈ to C₃₄, especially of C₁₂ to C₂₂, in particular of C₁₆ to C₂₀ and more particularly of C₁₈. A preferred fatty acid dimer is obtained by dimerization of linoleic acid, which may then be partially or totally hydrogenated.

Another preferred fatty acid dimer has the formula HOOC—(CH₂)₇—CH═CH—(CH₂)₇—COOH. Another preferred fatty acid dimer is obtained by dimerization of methyl linoleate. Similarly, fatty acid triacids and fatty acid tetracids may be found, which are obtained, respectively, by trimerization and tetramerization of at least one fatty acid.

According to a sixth variant of this embodiment, the organic compound is a compound of general formula (VI):

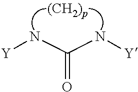

in which:
the groups Y and Y′ represent, independently of each other, an atom or group chosen from: H, —(CH₂)q-CH₃, —(CH₂)q-NH₂, —(CH₂)q-OH, —(CH₂)q-COOH or

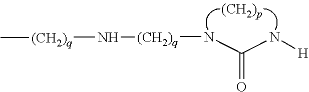

with q being an integer ranging from 2 to 18, preferably from 2 to 10, preferably from 2 to 4 and p being an integer greater than or equal to 2, preferably having a value of 2 or 3.

Among the preferred organic compounds corresponding to formula (VI), mention may be made of the following compounds:

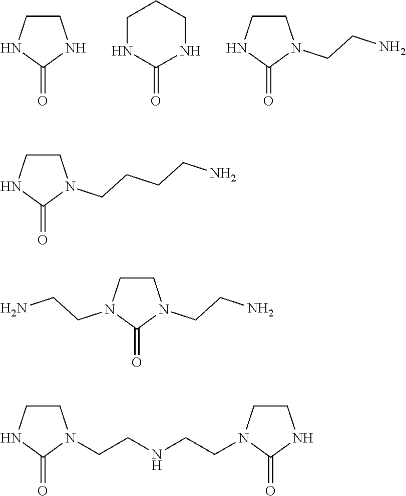 [SMILES: O=C1NCCN1 ; O=C1NCCCN1 ; NCCN1CCNC1=O ; NCCCCN1CCNC1=O ; NCCN1CCN(CCN)C1=O ; O=C1NCCN1CCNCCN1CCNC1=O]

Preferably, according to this variant, the organic compound of general formula (VI) is:

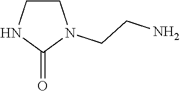

According to a seventh variant of this embodiment, the organic compound is a compound of general formula (VII):

R—NH—CO—CO—NH—R′ (VII)

in which R and R′, which may be identical or different, represent a saturated or unsaturated, linear, branched or cyclic hydrocarbon-based chain, comprising from 1 to 22 carbon atoms, preferably from 8 to 12 carbon atoms, which is optionally substituted, and optionally comprising heteroatoms, rings and/or heterocycles.

According to another embodiment of the invention, the chemical additive is a paraffin. Paraffins have chain lengths of from 30 to 120 carbon atoms (C₃₀ to C₁₂₀). The paraffins are advantageously chosen from polyalkylenes.

Preferably, use will be made according to the invention of polymethylene paraffins and polyethylene paraffins. These paraffins may be of petroleum origin or may originate from the chemical industry.

Advantageously, the paraffins used are synthetic paraffins derived the conversion of biomass and/or natural gas.

Preferably, these paraffins contain a large proportion of “normal” paraffins, i.e. linear, straight-chain, unbranched paraffins (saturated hydrocarbons). Thus, the paraffins may comprise from 50% to 100% of normal paraffins and from 0 to 50% of isoparaffins and/or of branched paraffins. More preferentially, the paraffins comprise from 85% to 95% of normal paraffins and from 5% to 15% of isoparaffins and/or of branched paraffins. Advantageously, the paraffins comprise from 50% to 100% of normal paraffins and from 0 to 50% of isoparaffins. Even more advantageously, the paraffins comprise from 85% to 95% of normal paraffins and from 5% to 15% of isoparaffins.

Preferably, the paraffins are polymethylene paraffins. More particularly, the paraffins are synthetic polymethylene paraffins, for example paraffins derived from the conversion of synthesis gas via the Fischer-Tropsch process. In the Fischer-Tropsch process, paraffins are obtained by reaction of hydrogen with carbon monoxide on a metal catalyst. Fischer-Tropsch synthetic processes are described, for example, in the publications EP 1 432 778, EP 1 328 607 or EP 0 199 475.

According to another embodiment of the invention, the chemical additive is a polyphosphoric acid. Polyphosphoric acids (PPA) that may be used in the invention are described in WO 97/14753. These are compounds of empirical formula PqHrOs in which q, r and s are positive numbers such that:

q≥2 and in particular q is from 3 to 20 or more and that 5q+r−2s=0.

In particular, said polyphosphoric acids may be linear compounds of empirical formula P_{q}H_{(q+2)}O_{(3q+1)} corresponding to the structural formula:

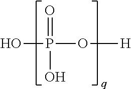

where q has the definition given above. They may also be products of two-dimensional or three-dimensional structure.

All these polyphosphoric acids may be considered as products of polycondensation by heating aqueous meta-phosphoric acid.

It would not constitute a departure from the scope of the invention to combine several different chemical additives such as different organic compounds of formulae (I), (II), (III), (V), (VI) and (VII), reaction products of at least one C₃-C₁₂ polyol and of at least one C₂-C₁₂ aldehyde, especially those comprising a group of formula (IV), and/or various paraffins and/or various polyphosphoric acids in the bitumen base.

According to an advantageous embodiment, the bituminous composition comprises at least two chemical additives.

According to a first variant of this embodiment, the bituminous composition comprises at least one first chemical additive of formula (V) and at least one second chemical additive chosen from: the chemical additives of formula (I); the chemical additives of formula (II); the chemical additives of formula (III); the chemical additives of formula (V); the chemical additives of formula (VI); the chemical additives of formula (VII) and the reaction products of at least one C₃-C₁₂ polyol and of at least one C₂-C₁₂ aldehyde, especially those comprising a group of formula (IV), the second chemical additive being different from the first chemical additive.

Preferably, and according to this first variant, the bituminous composition comprises at least one first chemical additive of formula (V) and at least one second chemical additive of formula (II).

More preferentially, and according to this first variant, the bituminous composition comprises at least one first additive of formula (V) and at least one second chemical additive of formula (IIA).

Preferably, and still according to this first variant, the first chemical additive of formula (V) is chosen from diacids (z=2), triacids (z=3) and tetracids (z=4), preferably from diacids (z=2).

More preferentially, and still according to this first variant, the first chemical additive of formula (V) is chosen from adipic acid or 1,6-hexanedioic acid with w=4, pimelic acid or 1,7-heptanedioic acid with w=5, suberic acid or 1,8-octanedioic acid with w=6, azelaic acid or 1,9-nonanedioic acid with w=7, sebacic acid or 1,10-decanedioic acid with w=8, undecanedioic acid with w=9, 1,2-dodecanedioic acid with w=10 or tetradecanedioic acid with w=12.

Advantageously, and according to this first variant, the first chemical additive of formula (V) is sebacic acid or 1,10-decanedioic acid with w=8.

According to a second variant of this embodiment, the bituminous composition comprises at least one first chemical additive of formula (II) and at least one second chemical additive chosen from: the chemical additives of formula (I); the chemical additives of formula (II); the chemical additives of formula (III); the chemical additives of formula (V); the chemical additives of formula (VI); the chemical additives of formula (VII) and the reaction products of at least one C₃-C₁₂ polyol and of at least one C₂-C₁₂ aldehyde, especially those comprising a group of formula (IV), the second chemical additive being different from the first chemical additive.

Preferably, and according to this second variant, the first chemical additive of formula (II) is chosen from the chemical additives of formula (IIA).

More preferentially, and according to this second variant, the bituminous composition comprises at least one first chemical additive of formula (IIA) and at least one second chemical additive chosen from: the chemical additives of formula (I); the chemical additives of formula (IIB); the chemical additives of formula (III); the chemical additives of formula (V); the chemical additives of formula (VI); the chemical additives of formula (VII) and the reaction products of at least one C₃-C₁₂ polyol and of at least one C₂-C₁₂ aldehyde, especially those comprising a group of formula (IV), the second chemical additive being different from the first chemical additive.

Even more preferentially, and according to this second variant, the bituminous composition comprises at least one first additive of formula (IIA) and at least one second additive of formula (V).

Advantageously, and according to this second variant, the first chemical additive of formula (IIA) is N,N′-ethylenedi(stearamide).

Preferably, and according to this second variant, the second additive of formula (V) is chosen from diacids (z=2), triacids (z=3) and tetracids (z=4), preferably from diacids (z=2).

Even more preferentially, and still according to this second variant, the second chemical additive of formula (V) is chosen from adipic acid or 1,6-hexanedioic acid with w=4, pimelic acid or 1,7-heptanedioic acid with w=5, suberic acid or 1,8-octanedioic acid with w=6, azelaic acid or 1,9-nonanedioic acid with w=7, sebacic acid or 1,10-decanedioic acid with w=8, undecanedioic acid with w=9, 1,2-dodecanedioic acid with w=10 or tetradecanedioic acid with w=12.

According to a third variant of this embodiment, the bituminous composition comprises at least sebacic acid or 1,10-decanedioic acid and at least N,N′-ethylenedi(stearamide).

According to a fourth variant of this embodiment, the bituminous composition comprises at least one first additive of formula (I) and at least one second chemical additive chosen from: the chemical additives of formula (I); the chemical additives of formula (II); the chemical additives of formula (III); the chemical additives of formula (V); the chemical additives of formula (VI); the chemical additives of formula (VII) and the reaction products of at least one C₃-C₁₂ polyol and of at least one C₂-C₁₂ aldehyde, especially those comprising a group of formula (IV), the second chemical additive being different from the first chemical additive.

Preferably, and according to this fourth variant, the second chemical additive is chosen from the chemical additives of formula (II) and the chemical additives of formula (V).

Preferably, and according to this fourth variant, the second chemical additive of formula (II) is chosen from the chemical additives of formula (IIA).

More preferentially, and according to this fourth variant, the second chemical additive of formula (II) is N,N′-ethylenedi(stearamide).

Preferably, and still according to this fourth variant, the second chemical additive of formula (V) is chosen from diacids (z=2), triacids (z=3) and tetracids (z=4), preferably from diacids (z=2).

Even more preferentially, and still according to this fourth variant, the second chemical additive of formula (V) is chosen from adipic acid or 1,6-hexanedioic acid with w=4, pimelic acid or 1,7-heptanedioic acid with w=5, suberic acid or 1,8-octanedioic acid with w=6, azelaic acid or 1,9-nonanedioic acid with w=7, sebacic acid or 1,10-decanedioic acid with w=8, undecanedioic acid with w=9, 1,2-dodecanedioic acid with w=10 or tetradecanedioic acid with w=12.

Advantageously, and still according to this fourth variant, the second chemical additive of formula (V) is sebacic acid or 1,10-decanedioic acid.

Preferably, and according to this fourth variant, the first chemical additive of formula (I) is 2′,3-bis[(3-[3,5-ditert-butyl-4-hydroxyphenyl]propionyl)]-propionohydrazide.

Preferably, and according to this embodiment, the mass ratio of the first chemical additive relative to the second chemical additive is from 1:99 to 99:1, preferably from 1:9 to 9:1, even more preferentially from 1:5 to 5:1.

According to a first embodiment of the invention, the supplemented bituminous composition comprises from 0.1% to 10% by mass, preferably from 0.5% to 5% by mass, more preferentially from 0.5% to 2.8% by mass and even more preferentially from 0.5% to 2.5% by mass of chemical additive relative to the total mass of the bituminous composition.

According to another embodiment of the invention, the supplemented bituminous composition according to the invention is a concentrated bituminous composition. In this case, before its use, for example in an application described below, the concentrated supplemented bituminous composition is melted and then diluted with at least one other non-supplemented bituminous composition. This dilution is calculated to achieve an additive content of from 0.1% to 10% by mass, preferably from 0.5% to 5% by mass, more preferentially from 0.5% to 2.8% by mass and even more preferentially from 0.5% to 2.5% by mass of chemical additive relative to the total weight of the bituminous composition.

According to this embodiment, the concentrated supplemented bituminous composition comprises from 5% to 30% by mass, preferably from 6% to 28% by mass and more preferentially from 7% to 26% by mass of chemical additive(s) relative to the total mass of said base of the bituminous composition.

According to one embodiment of the invention, the supplemented bituminous composition may also comprise at least one olefinic polymer adjuvant.

The olefinic polymer adjuvant is preferably chosen from the group consisting of (a) ethylene/glycidyl (meth)acrylate copolymers; (b) ethylene/monomer A/monomer B terpolymers and (c) copolymers resulting from the grafting of a monomer B onto a polymer substrate.
(a) The ethylene/glycidyl (meth)acrylate copolymers are advantageously chosen from random or block, preferably random, copolymers of ethylene and of a monomer chosen from glycidyl acrylate and glycidyl methacrylate, comprising from 50% to 99.7% by mass, preferably from 60% to 95% by mass, more preferentially from 60% to 90% by mass, of ethylene.
(b) The terpolymers are advantageously chosen from random or block, preferably random, terpolymers of ethylene, of a monomer A and of a monomer B.
   Monomer A is chosen from vinyl acetate and C₁ to C₆ alkyl acrylates or methacrylates.
   Monomer B is chosen from glycidyl acrylate and glycidyl methacrylate.
   The ethylene/monomer A/monomer B terpolymers comprise from 0.5% to 40% by mass, preferably from 5% to 35% by mass and more preferentially from 10% to 30% by mass of units derived from monomer A, and from 0.5% to 15% by mass and preferably from 2.5% to 15% by mass of units derived from monomer B, the remainder being formed from units derived from ethylene.
(c) The copolymers result from the grafting of a monomer B chosen from glycidyl acrylate and glycidyl methacrylate onto a polymer substrate. The polymer substrate consists of a polymer chosen from polyethylenes, especially low-density polyethylenes, polypropylenes, random or block, preferably random, copolymers of ethylene and of vinyl acetate, and random or block, preferably random, copolymers of ethylene and of C₁ to C₆ alkyl acrylate or methacrylate, comprising from 40% to 99.7% by mass and preferably from 50% to 99% by mass of ethylene. Said grafted copolymers comprise from 0.5% to 15% by mass and preferably from 2.5% to 15% by mass of grafted units derived from monomer B.

Advantageously, the olefinic polymer adjuvant is chosen from random terpolymers of ethylene (b), of a monomer A chosen from C₁ to C₆ alkyl acrylates or methacrylates and of a monomer B chosen from glycidyl acrylate and glycidyl methacrylate, comprising from 0.5% to 40% by mass, preferably from 5% to 35% by mass and more preferentially from 10% to 30% by mass of units derived from monomer A, and from 0.5% to 15% by mass and preferably from 2.5% to 15% by mass of units derived from monomer B, the remainder being formed from units derived from ethylene.

According to one embodiment of the invention, the bituminous composition comprises from 0.05% to 15% by mass, preferably from 0.1% to 10% by mass and more preferentially from 0.5% to 6% by mass of olefinic polymer adjuvant relative to the total mass of said bituminous composition.

According to a particular embodiment, a bituminous composition which is solid under cold conditions and in divided form is prepared by placing in contact:
at least one bituminous composition as defined above,
from 0.1% to 5% by mass, preferably from 0.5% to 4% by mass, more preferentially from 0.5% to 2.8% by mass and even more preferentially from 0.5% to 2.5% by mass of at least one chemical additive chosen from an organic compound, a paraffin, a polyphosphoric acid, and mixtures thereof, the percentages being on a mass basis relative to the total mass of the bituminous composition.

According to another particular embodiment, a concentrated bituminous composition which is solid under cold conditions and in divided form is prepared by placing in contact:
at least one bituminous composition as defined above,
from 5% to 30% by mass, preferably from 6% to 28% by mass and more preferentially from 7% to 26% by mass of at least one chemical additive chosen from an organic compound, a paraffin, a polyphosphoric acid, and mixtures thereof,
the percentages being on a mass basis relative to the total mass of the bituminous composition.

The amounts of chemical additive(s) and, optionally, of olefinic polymer adjuvant are adjusted according to the nature of the bituminous composition used.

Process for Transporting and/or Storing and/or Handling the Bituminous Composition which is Solid Under Cold Conditions and in Divided Form

Another subject of the invention also relates to a process for transporting and/or storing and/or handling the bituminous composition which is solid under cold conditions and in divided form, said bituminous composition being transported and/or stored and/or handled in the form of blocks or pellets of bituminous composition which are solid at ambient temperature, especially at elevated ambient temperature. The bituminous composition which is solid under cold conditions and in divided form is as described above.

The term “ambient temperature” or “elevated ambient temperature” means the temperature resulting from the climatic conditions under which the bitumen is transported and/or stored. More specifically, the ambient temperature is equivalent to the temperature reached during the transportation and/or storage and/or handling of the bitumen, it being understood that the ambient temperature implies that no heat is supplied other than that resulting from the climatic conditions.

Preferably, the supplemented bituminous composition of the invention is transported and/or stored and/or handled at ambient temperature for a duration of more than or equal to 2 months, preferably 3 months.

According to one embodiment of the invention, the supplemented bituminous composition of the invention is transported and/or stored at a temperature below 100° C. In particular, the transportation and/or storage and/or handling temperature corresponds to the ambient temperature. The term “ambient temperature” means the temperature which is reached during the transportation and/or storage of the bituminous composition according to the invention without said bituminous composition being heated via any type of process. Thus, the ambient temperature may reach elevated temperatures, below 100° C. during summer periods, in particular in geographical regions with a hot climate.

Preferably, the elevated ambient temperature is below 100° C.

Advantageously, the elevated ambient temperature is from 20° C. to 90° C., preferably from 20° C. to 80° C. and more preferentially from 30° C. to 80° C.

The bituminous compositions which are solid under cold conditions and in divided form according to the present invention are noteworthy in that they allow the transportation and/or storage of the bituminous composition under cold conditions under optimum conditions, in particular without said solid bituminous compositions undergoing creep during their transportation and/or storage, even when the ambient temperature is elevated, and without degrading the properties of said bituminous composition, or even with said properties being improved.

Bitumen block

According to one embodiment of the invention, the bituminous composition which is solid under cold conditions and in divided form is in block form. For the purposes of the invention, the bituminous composition in block form is also known as a bitumen slab.

The term “bitumen block” means a block of bituminous composition according to the invention having a mass of between 1 kg and 1000 kg, preferably between 1 kg and 200 kg, more preferentially between 1 kg and 50 kg, even more preferentially between 5 kg and 25 kg, even more preferentially between 10 kg and 30 kg, said block being advantageously parallelepipedal, preferably being like a paving stone.

The bitumen block according to the invention preferably has a volume of between 1000 cm³ and 50 000 cm³, preferably between 5000 cm³ and 25 000 cm³, more preferentially between 10 000 cm³ and 30 000 cm³, even more preferentially between 14 000 cm³ and 25 000 cm³.

When the bitumen block is handled manually by a person, the mass of the bituminous composition may range from 1 to 20 kg, and from 20 to 50 kg when handled by two people. When the handling is performed by mechanical equipment, the mass of the bitumen block may range from 50 to 1000 kg.

The bitumen block is manufactured from the supplemented bituminous composition as described above according to any industrially known process, for example by extrusion, by molding, or according to the manufacturing process described in US 2011/0290695.

Advantageously, the bitumen block is wrapped in a hot-melt film according to any known process, preferably with a film made of polypropylene or polyethylene or a mixture of polyethylene and polypropylene. The bituminous composition packaged as a bitumen block wrapped in a hot-melt film has the advantage of being ready to use, i.e. it may be heated directly in the melting machine without being unwrapped beforehand, for example for the manufacture of emulsion, or may optionally be introduced directly into the coating unit for the manufacture of surfacing mixes. The hot-melt material which melts with the supplemented bituminous composition does not affect the properties of said bituminous composition.

The bitumen block according to the invention may also be covered with anticaking compound as defined above.

In this variant, the preferences, the advantages and the various embodiments described for the anticaking compounds also apply.

The bitumen block according to the invention may also be packaged in a cardboard container according to any known process.

In particular, the bitumen block according to the invention is packaged in a cardboard container by hot-casting the bituminous composition according to the invention in a cardboard container, the wall of the inner face of which is siliconized, and then cooled, the dimensions of the cardboard container being suited to the weight and/or volume of the desired bitumen block.

When the bitumen block according to the invention is wrapped in a hot-melt film or is packaged in a cardboard container, the Applicant has demonstrated that the deterioration of said hot-melt film or of said cardboard container during the transportation and/or storage under cold conditions of said bitumen block did not lead to the bituminous composition undergoing creep. Consequently, the bitumen blocks according to the invention retain their initial form and do not stick together during the transportation and/or storage thereof under cold conditions, even if the hot-melt film or the cardboard container is damaged. The absence of creep of the bituminous composition in block form during the transportation and/or storage thereof under cold conditions is due to the presence of at least one chemical additive in the bituminous composition.

### Bitumen Pellets

According to another embodiment of the invention, the bituminous composition which is solid under cold conditions and in divided form is in the form of pellets. For the purposes of the invention, the bituminous composition in the form of pellets is also known as bitumen granules.

The bitumen pellets according to the invention may have, within the same population of pellets, one or more shapes chosen from a cylindrical, spherical or ovoid shape. More specifically, the bitumen pellets according to the invention preferably have a cylindrical or spherical shape.

The size of the bitumen pellets may vary depending on the manufacturing process employed.

According to one embodiment of the invention, the size of the bitumen pellets is such that the longest mean dimension is preferably less than or equal to 50 mm, more preferentially from 3 to 30 mm, even more preferentially from 5 to 20 mm. For example, the use of a die makes it possible to control the manufacture of pellets of a chosen size. Screening makes it possible to select pellets as a function of their size.

Preferably, the bitumen pellets according to the invention have a weight of between 0.1 g and 50 g, preferably between 0.2 g and 10 g and more preferentially between 0.2 g and 5 g.

According to another embodiment of the invention, the size of the bitumen pellets is such that the longest mean dimension is preferably less than 20 mm, more preferentially less than 10 mm and even more preferentially less than 5 mm.

The bitumen pellets are obtained by forming a supplemented bituminous composition according to the invention as described above according to any known process, for example according to the manufacturing process described in U.S. Pat. No. 3,026,568, WO 2009/153324 or WO 2012/168380. According to a particular embodiment, the forming of the pellets may be performed by draining, in particular using a drum.

Other techniques may be used in the process for manufacturing the bituminous composition pellets, in particular molding, extrusion, pelletizing, etc.

According to one embodiment of the invention, the bitumen pellets also comprise at least one anticaking agent, preferably of mineral or organic origin.

Preferably, the bitumen pellets also comprise between 0.5% and 20% by mass, preferably between 2% and 20% by mass and more preferably between 4% and 15% by mass of the anticaking agent relative to the total mass of supplemented bituminous composition of said pellets.

In this embodiment, the bitumen pellets are prepared from the bituminous composition according to the invention as defined above, said pellets being prepared by placing in contact:
one or more supplemented bituminous compositions according to the invention,
between 0.1% and 5% by mass, preferably between 0.5% and 4% by mass, more preferentially between 0.5% and 2.8% by mass and even more preferentially between 0.5% and 2.5% by mass of at least one chemical additive chosen from an organic compound, a paraffin, a polyphosphoric acid, and mixtures thereof, relative to the total mass of supplemented bituminous composition of said pellets, and
between 0.5% and 20% by mass, preferably between 2% and 20% by mass and more preferentially between 4% and 15% by mass of the anticaking agent relative to the total mass of supplemented bituminous composition of said pellets.

According to one embodiment of the invention, the bitumen pellets are covered, over at least part of their surface, with an anticaking agent, preferably over the whole of their surface.

Preferably, the mass of the anticaking agent covering at least part of the surface of the pellets is between 0.2% and 10% by mass, preferably between 0.5% and 8% by mass, more preferentially between 0.5% and 5% relative to the total mass of the supplemented bituminous composition of said pellets.

Advantageously, the mass of the anticaking agent covering at least part of the surface of the pellets is about 1% by mass relative to the total mass of the supplemented bituminous composition of said pellets.

Preferably, the anticaking layer covering the bitumen pellets according to the invention is preferably continuous so that at least 90% of the surface of said pellets is covered with an anticaking agent, preferably at least 95%, more preferentially at least 99%.

Also preferably, the average thickness of the anticaking layer is preferably greater than or equal to 20 μm, more preferentially between 20 and 100 μm.

Advantageously, the anticaking layer must be sufficiently thick so that it is continuous.

The pellets according to the invention are covered with the anticaking agent according to any known process, for example according to the process described in U.S. Pat. No. 3,026,568.

The term “anticaking agent” or “anticaking compound” means any compound which limits, reduces, inhibits or delays the agglomeration and/or adhesion of the pellets together during their transportation and/or storage at ambient temperature and which ensures their fluidity during handling.

More preferentially, the anticaking agent is chosen from talc; fines generally less than 125 μm in diameter, with the exception of limestone fines, such as siliceous fines; sand, such as Fontainebleau sand; cement; carbon; wood residues, such as lignin, lignosulfonate, conifer needle powders or conifer cone powders, in particular of pine; rice husk ash; glass powder; clays, such as kaolin, bentonite or vermiculite; alumina, such as alumina hydrates; silica; silica derivatives, such as fumed silica, functionalized fumed silica, in particular hydrophobic or hydrophilic fumed silica, pyrogenic silicas, in particular hydrophobic or hydrophilic pyrogenic silicas, silicates, silicon hydroxides and silicon oxides; plastic powder; lime; plaster; rubber powder; polymer powder, where the polymers are such as styrene/butadiene (SB) copolymers or styrene/butadiene/styrene (SBS) copolymers; and mixtures thereof.

Advantageously, the anticaking agent is chosen from talc; fines generally less than 125 μm in diameter, with the exception of limestone fines, such as siliceous fines; wood residues such as lignin, lignosulfonate, conifer needle powders, conifer cone powders, in particular pine powders; glass powder; sand such as Fontainebleau sand; fumed silicas, in particular hydrophobic and hydrophilic fumed silicas; pyrogenic silicas, in particular hydrophilic or hydrophobic pyrogenic silicas; and mixtures thereof.

By way of example, the anticaking agent may be fumed silicas. The fumed silicas used in the invention are commercially available and may, for example, be sold by Evonik Degussa under the brand name Aerosil®, for instance Aerosil® 200, by Cabot Corporation under the brand names Cab-O-Sil® and Cab-O-Sperse® or by Wacker Chemie AG under the brand name HDK®.

The anticaking compound is preferably chosen from fumed silicas.

For the purposes of the invention, the “fumed silica” and “pyrogenic silica” compounds have the same chemical definition and are recorded under the same number CAS 112 945-52-5. Consequently, for the purposes of the invention, these compounds may be employed without discrimination between them.

The term “fumed silica” means either a fumed silica or a fumed silica derivative.

The term “fumed silica” means a compound obtained by the vapor-phase hydrolysis of chlorosilanes, such as silicon tetrachloride, in a flame of oxygen and hydrogen. Such processes are generally termed pyrogenic processes, the overall reaction of which is: SiCl₄+H₂+O₂→SiO₂+4 HCl.

Fumed silicas are distinguished from the other silicon dioxides in that they have an amorphous structure. These silicas, of high purity (>99.8% silica), have a weak hydrophilic nature (no microporosity).

Preferably, the fumed silica compound is fumed silica.

According to one embodiment of the invention, the fumed silica compound has a specific surface area of between 25 and 420 m²/g, preferentially between 90 and 330 m²/g, more preferentially between 120 and 280 m²/g.

The specific surface area of the fumed silica, defined in m²/g, commonly known as the “surface area” or “SA”, is measured according to the method of S. Brunauer, P. H. Emmett and I. Teller, J. Am. Chemical Society, 60: 309 (1938) (BET).

According to one embodiment of the invention, the fumed silica compound has a mean particle size of between 5 and 50 nm.

According to one embodiment of the invention, the fumed silica compound has a pH of between 3 and 10, when it is in the aqueous phase.

According to one embodiment of the invention, the fumed silica compound has a carbon content of between 0.1% and 10% by weight, relative to the total weight of the fumed silica compound.

According to one embodiment of the invention, the fumed silica compound is chosen from a hydrophilic fumed silica compound, a hydrophobic fumed silica compound, and mixtures thereof.

Preferably, the fumed silica compound is a hydrophilic fumed silica compound.

The term “hydrophilic” refers to a compound which is miscible with water in all proportions.

The fumed silica compound, or fumed silica derivative, used within the meaning of the invention may be chemically modified.

Various types of fumed silica compounds are described in the following patent applications and can be used in the present invention:
silanized fumed silicas, as described in WO 2004/020532 or in WO 2007/128636,
hydrophilic fumed silicas, as described in WO 2009/071467 and WO 2011/000133, filed in the name of Degussa AG or Degussa GmbH,
fumed silicas rendered hydrophobic by a treatment using polysiloxanes, as described in WO 2008/141932, or by silanization, as described in WO 2008/141930,
silicas doped with potassium oxide, as described in WO 2008/043635 and WO 2008/022836,
silicas in the form of aggregates of primary particles, as described in WO 2009/015969, filed in the name of Evonik Degussa GmbH, or in WO 2010/028261, filed in the name of Cabot Corporation.
   The fumed silica compound may be used alone or as a mixture in a coating composition.

Whether it is used alone or as a mixture in a composition, the fumed silica compound may be used in the process according to the invention in the form of a powder or as a dispersion in a solvent which evaporates after application.

Preferably, when the coating composition comprises at least one fumed silica compound and at least one solvent, the coating composition comprises from 5% to 70% by weight of fumed silica compound relative to the total weight of the composition, more preferentially from 20% to 40% by weight.

Preferably, the solvent is an organic solvent or water. The term “organic solvent” means any solvent which is immiscible with a bitumen, such as an alcohol, for example ethanol.

According to one embodiment of the invention, the anticaking agent included in the bituminous composition forming the bitumen pellets may be identical to or different from the anticaking agent covering at least part of the surface of said bitumen pellets.

According to one embodiment of the invention, the bitumen pellets comprise a core and a coating layer in which:
the core comprises at least one supplemented bituminous composition according to the invention as defined above, and
the coating layer comprises at least one viscosifying compound and at least one anticaking compound as defined above.

The term “coating layer” means that the coating layer covers at least 90% of the surface of the core, preferably at least 95% of the surface of the core and more preferentially at least 99% of the surface of the core.

The term “viscosifying agent” or “viscosifying compound” means a compound which has the property of decreasing the fluidity of a liquid or a composition and thus of increasing the viscosity thereof.

For the purposes of the invention, the terms “viscosifying agent” and “viscosifying compound” are used equivalently and independently of each other. For the purposes of the invention, the viscosifying agent is a material with a dynamic viscosity greater than or equal to 50 mPa·s⁻¹, preferably from 50 mPa·s⁻¹ to 550 mPa·s⁻¹, more preferentially from 80 mPa·s⁻¹ to 450 mPa·s⁻¹, the viscosity being a Brookfield viscosity measured at 65° C. The viscosity of a viscosifying agent according to the invention is measured at 65° C. by means of a Brookfield CAP 2000+ viscometer and at a rotation speed of 750 rpm. The measurement is read after 30 seconds for each temperature.

Preferably, the viscosifying agent is chosen from:
gelling compounds preferably of plant or animal origin, such as: gelatin, agar-agar, alginates, cellulose derivatives, starches, modified starches, or gellan gums;
polyethylene glycols (PEG) such as PEGs with a molecular weight of between 800 g·mol⁻¹ and 8000 g·mol⁻¹, for instance a PEG with a molecular weight of 800 g·mol⁻¹ (PEG-800), a PEG with a molecular weight of 1000 g·mol⁻¹ (PEG-1000), a PEG with a molecular weight of 1500 g·mol⁻¹ (PEG-1500), a PEG with a molecular weight of 4000 g·mol⁻¹ (PEG-4000) or a PEG with a molecular weight of 6000 g·mol⁻¹ (PEG-6000);
mixtures of such compounds.

Advantageously, the viscosifying agent is chosen from:
gelling compounds preferably of plant or animal origin, such as gelatin, agar agar, alginates, cellulose derivatives or gellan gums;
polyethylene glycols (PEG) such as PEGs with a molecular weight of between 800 g·mol⁻¹ and 8000 g·mol⁻¹, for instance a PEG with a molecular weight of 800 g·mol⁻¹ (PEG-800), a PEG with a molecular weight of 1000 g·mol⁻¹ (PEG-1000), a PEG with a molecular weight of 1500 g·mol⁻¹ (PEG-1500), a PEG with a molecular weight of 4000 g·mol⁻¹ (PEG-4000) or a PEG with a molecular weight of 6000 g·mol⁻¹ (PEG-6000);
mixtures of such compounds.

According to one embodiment of the invention, the coating layer is obtained by applying a composition comprising at least one viscosifying compound and at least one anticaking compound over all or part of the surface of the core made of solid bituminous composition.

Preferably, the coating layer is solid at ambient temperature, including at elevated ambient temperature.

Preferably, the composition comprising at least one viscosifying compound and at least one anticaking compound has a viscosity of greater than or equal to 200 mPa·s⁻¹, preferably between 200 mPa·s⁻¹ and 700 mPa·s⁻¹, the viscosity being a Brookfield viscosity.

Preferentially, the coating layer comprises at least 10% by mass of at least one viscosifying compound relative to the total mass of the coating layer, preferably from 10% to 90% by mass and more preferentially from 10% to 85% by mass.

Advantageously, when the viscosifying agent is a gelling agent, for instance gelatin, the coating layer comprises from 10% to 90% by mass of viscosifying compound relative to the total mass of the coating layer, preferably from 15% to 85% by weight and better still from 15% to 60%.

Advantageously, when the viscosifying agent is a gelling agent, for instance gelatin, the coating layer comprises from 10% to 90% by mass of anticaking compound relative to the total mass of the coating layer, preferably from 15% to 85% and better still from 40% to 85%.

Advantageously, when the viscosifying agent is a PEG, for instance a PEG with a molecular weight of between 800 g·mol⁻¹ and 8000 g·mol⁻¹, the coating layer comprises from 10% to 90% by mass of viscosifying compound relative to the total mass of the coating layer, preferably from 40% to 90% and better still from 60% to 90%.

Advantageously, when the viscosifying agent is a PEG, for instance a PEG with a molecular weight of between 800 g·mol⁻¹ and 8000 g·mol⁻¹, the coating layer comprises from 10% to 90% by mass of anticaking compound relative to the total mass of the coating layer, preferably from 10% to 60% and better still from 10% to 40%.

Preferentially, the coating layer comprises at least 10% by mass of an anticaking compound relative to the total mass of the coating layer, preferably from 10 to 90% by mass and even more preferentially from 15 to 90% by mass.

Preferably, the coating layer represents at least 5% by mass relative to the total mass of the pellets, preferably from 10 to 60% by mass and more preferentially from 10 to 50%.

Advantageously, the viscosifying compound and the anticaking compound represent at least 90% by mass relative to the total mass of the coating layer, better still at least 95% by mass and advantageously at least 98% by mass.

According to a preferred embodiment, the coating layer is essentially constituted of the viscosifying compound and of the anticaking compound.

Besides the viscosifying compound and the anticaking compound, the coating layer may optionally comprise one or more compounds chosen from: chemical additives, polymers, etc.

According to a preferred embodiment of the invention, the bitumen pellets have:
a core comprising at least one bituminous composition according to the invention as defined above, and
a coating layer comprising gelatin or a PEG and at least one anticaking compound chosen from fines generally less than 125 μm in diameter; wood residues such as lignin, conifer needle powders and conifer cone powders; rubber crumb; SBS copolymer powder; fumed silicas, in particular hydrophilic and hydrophobic fumed silicas; pyrogenic silicas, in particular hydrophobic or hydrophilic pyrogenic silicas; and mixtures thereof.

More preferably, the bitumen pellets have:
a core comprising at least one bituminous composition according to the invention as defined above, and
a coating layer comprising gelatin or a PEG and at least one anticaking compound chosen from fines generally less than 125 μm in diameter; lignin; rubber crumb; fumed silicas, in particular hydrophilic and hydrophobic fumed silicas; pyrogenic silicas, in particular hydrophobic or hydrophilic pyrogenic silicas; SBS copolymer powder.

According to a more preferred embodiment, the bitumen pellets are essentially constituted of:
a core constituted of a supplemented bitumen composition according to the invention as defined above, and
a coating layer constituted of a mixture of gelatin or of a PEG, with at least one anticaking compound chosen from fines generally less than 125 μm in diameter; lignin; rubber crumb; SBS copolymer powder; fumed silicas, in particular hydrophilic and hydrophobic fumed silicas; pyrogenic silicas, in particular hydrophobic or hydrophilic pyrogenic silicas.

Preferentially, the bitumen pellets are essentially constituted of:
a core constituted of a supplemented bituminous composition as defined above comprising at least one chemical additive chosen from an organic compound, a paraffin, a polyphosphoric acid, and mixtures thereof, and
a coating layer constituted of a mixture of gelatin or of a PEG, with at least one anticaking compound chosen from fines generally less than 125 μm in diameter; lignin; rubber crumb; SBS copolymer powder; fumed silicas, in particular hydrophilic and hydrophobic fumed silicas; pyrogenic silicas, in particular hydrophobic or hydrophilic pyrogenic silicas.

According to another more preferred embodiment, the bitumen pellets are essentially constituted of:
a core constituted of a supplemented bituminous composition according to the invention as defined above, comprising a chemical additive of formula (I) defined below, and
a coating layer constituted of a mixture of gelatin or of a PEG, with at least one anticaking compound chosen from fines generally less than 125 μm in diameter; lignin; rubber crumb; SBS copolymer powder; fumed silicas, in particular hydrophilic and hydrophobic fumed silicas; pyrogenic silicas, in particular hydrophobic or hydrophilic pyrogenic silicas.

According to another more preferred embodiment, the bitumen pellets are essentially constituted of:
a core constituted of a supplemented bituminous composition according to the invention as defined above, comprising a chemical additive of formula (I) defined below, and
a coating layer constituted of a mixture of gelatin or of a PEG, with at least one anticaking compound chosen from fumed silicas, in particular hydrophilic and hydrophobic fumed silicas; pyrogenic silicas, in particular hydrophobic or hydrophilic pyrogenic silicas.

According to one embodiment of the invention, the bitumen pellets may also comprise one or more other coating layers, based on anticaking agent covering all or part of the coating layer of the bituminous composition which is solid under cold conditions according to the invention.

Kit of Bitumen which is Solid Under Cold Conditions and in Divided Form

Another subject of the invention relates to a kit comprising at least:
a bitumen base which is solid under cold conditions and in divided form as defined above,
a capsule comprising at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, in the form of pellets.

Such a kit allows the manufacture of a bituminous composition according to the invention under facilitated implementation conditions. In particular, the proportion of bitumen base which is solid under cold conditions and in divided form and of pitch is calculated during the manufacture of the kit, which avoids the need to measure out the amount of pitch during the manufacture of the bituminous composition.

According to one embodiment of the invention, the bitumen base which is solid under cold conditions and in divided form is a bitumen base comprising at least one additive as defined above.

According to a particular embodiment, a bitumen base which is solid under cold conditions and in divided form is prepared by placing in contact:
at least one bitumen base as defined above,
from 0.1% to 5% by mass, preferably from 0.5% to 4% by mass, more preferentially from 0.5% to 2.8% by mass and even more preferentially from 0.5% to 2.5% by mass of at least one chemical additive chosen from an organic compound, a paraffin, a polyphosphoric acid, and mixtures thereof, the percentages being on a mass basis relative to the total mass of the bitumen base.

According to one embodiment of the invention, the bitumen base which is solid under cold conditions and in divided form is in block form.

The embodiments described above for the bitumen block also apply to the bitumen base block.

According to one embodiment of the invention, the bitumen base in block form comprises, on one face thereof, a cavity making it possible to house all or part of the capsule.

According to one embodiment of the invention, the capsule is removably housed entirely or partially in the cavity.

According to this embodiment, the capsule may be a capsule with a soft casing, especially a sachet, or a capsule with a hard casing.

The capsule is preferably made of hot-melt plastic film, especially made of polyethylene, or made of silicone.

Another subject of the invention relates to the use of the kit as defined above in the process for preparing a ready-to-apply bituminous composition according to the invention.

According to one embodiment of the invention, the bitumen base in block form and the capsule forming the kit as defined above are used simultaneously or consecutively in the process for preparing a bituminous composition.

In one variant, when the bitumen base in block form and the capsule forming the kit as defined above are used consecutively in the process for preparing a bituminous composition, said bitumen base in block form is first heated, and the capsule is then added. In this variant, before the bitumen base block is heated, the capsule is dislodged from the cavity present on one of the faces of the block.

In another variant, when the bitumen base in block form and the capsule forming the kit as defined above are used simultaneously in the process for preparing a bituminous composition.

### Bituminous Surfacing Mixes or Bituminous Concretes

The invention relates to the use of the bituminous composition according to the invention described above for the manufacture of bituminous surfacing mixes or bituminous concretes.

The invention also relates to bituminous surfacing mixes or bituminous concretes comprising the composition according to the invention as defined above and aggregates.

The invention also relates to a process for manufacturing bituminous surfacing mixes or bituminous concretes comprising at least one bituminous composition and aggregates, the bituminous composition being chosen from bituminous compositions which are solid under cold conditions and in divided form according to the invention as defined above, this process comprising at least the steps of:
heating the aggregates to a temperature ranging from 100° C. to 180° C.,
mixing the aggregates with the bituminous composition in a tank such as a mixer or a mixing drum,
obtaining surfacing mixes.

The process of the invention has the advantage of being able to be performed without a preliminary step of heating the solid bitumen pellets. According to one embodiment of the invention, the process does not include a step of heating the bituminous composition which is solid under cold conditions and in divided form, before it is mixed with the aggregates.

The process for manufacturing surfacing mixes according to the invention does not require a step of heating of the solid bituminous composition before mixing with the aggregates, since, on contact with the hot aggregates, the bitumen which is solid at ambient temperature melts.

The bitumen which is solid at ambient temperature according to the invention as described above has the advantage of being able to be added directly to the hot aggregates, without having to be melted prior to mixing with the hot aggregates.

Preferably, the step of mixing of the aggregates and of the road binder is performed with stirring, and stirring is then maintained for not more than 5 minutes, preferably not more than 1 minute to allow the production of a homogeneous mixture.

The solid bitumen according to the present invention is noteworthy in that it allows the transportation and/or storage of road bitumen at ambient temperature under optimum conditions, in particular without there being agglomeration and/or adhesion of the solid bitumen during its transportation and/or storage, even when the ambient temperature is elevated.

The various embodiments, variants, preferences and advantages described above for each of the subjects of the invention apply to all the subjects of the invention and may be taken separately or in combination.

The invention is illustrated by the following examples, which are given without any implied limitation.

Experimental Section:

Material and Methods

The properties of the bitumens are measured by means of the methods described below:
Needle penetrability at 25° C. (P25): units= 1/10 mm, standard EN 1426
Ring and ball softening point (RBSP): units=° C., standard EN 1427
Fraass fragility point (Fraass): units=° C., standard EN 12593
Complex modulus G* of the bituminous composition measured at 15° C. and at 60° C. and at a frequency of 10 Hz: units=MPa or Pa, standard EN 14770
Complex stiffness modulus of the bituminous surfacing mixes measured at 15° C. and at a frequency of 10 Hz: units=MPa, standard EN 12697-24-26

Starting Materials:
Bitumen Base (B): several bitumen bases were used, the characteristics of which are presented below in table 1:

TABLE 1
characteristics of bitumen bases tested

| | | Penetrability | |
|---|---|---|---|
| | Commercial name or composition | P₂₅ | RBSP |
| B1 | Azalt ® 50/70 (bitumen base) | 50 | 51.1° C. |
| B2 | Azalt ® 35/50 (bitumen base) | 40 | 51.6° C. |
| B3 | Bitumen base of Ghanaian origin | 125 | 42.0° C. |
| B4 | Bitumen base of Ghanaian origin | 89 | 45.6° C. |
| B5 | Stelox ®110/30 (oxidized bitumen) | 25 | 113 |
| B6 | Modulotal ® (hard-grade bitumen | 16 | 65.4 |
| | used for the manufacture of high- | | |
| | modulus surfacing mixes) | | |

Gilsonite (G) sold commercially by Hillington under the brand name H103 M®
Pitch (PIT): several pitches were used, the characteristics of which are presented below in table 2:

TABLE 2
characteristics of the pitches tested

| | Penetrability | |
|---|---|---|
| | P₂₅ | RBSP |
| PIT1 | 0-2 | 115-125° C. |
| PIT2 | 0-2 | 135-145° C. |
| PIT3 | 0-2 | 165-175° C. |

### I—Preparation of the Compositions According to the Invention and of the Control Compositions:

Starting with the bitumen bases B1 to B6 and the pitches PIT1 to PIT3 or gilsonite G, bituminous compositions were prepared according to the following protocol:

The bitumen base BX (X=1 to 4) was brought to 180° C. and pitch (or gilsonite or the base B5 or B6) was added at a temperature of 180° C. The mixture was kept stirring at 180° C. for 1 hour and at 300 rpm.

Compositions C1 to C10 thus obtained are summarized in table 3A below. The contents are given on a mass basis relative to the total mass of the composition:

TABLE 3A
Bituminous compositions accordinq to the invention

| | Composition | | | | | | | | | |
|---|---|---|---|---|---|---|---|---|---|---|
| | C1 | C2 | C3 | C4 | C5 | C6 | C7 | C8 | C9 | C10 |
| B1 | 88% | 88% | — | — | — | — | — | — | — | — |
| B2 | — | — | 95% | 85% | 90% | 80% | — | — | — | — |
| B3 | — | — | — | — | — | — | 95% | — | 97% | — |
| B4 | — | — | — | — | — | — | — | 95% | — | 97% |
| PIT1 | 12% | — | — | — | — | — | — | — | — | — |
| PIT2 | — | 12% | — | — | 10% | 20% | 5% | 5% | — | — |
| PIT3 | — | — | 5% | 15% | — | — | — | — | 3% | 3% |

Compositions T1 to T3 thus obtained are summarized in table 3B below. The contents are given on a mass basis relative to the total mass of the composition:

TABLE 3B
Control bituminous compositions

| Composition | T1 | T2 | T3 |
|---|---|---|---|
| B1 | 61% | 88% | 88% |
| B5 | — | 12% | — |
| B6 | 39% | — | — |
| G | — | — | 12% |

Compositions C1 to C10 and the control compositions T1 and T2 have homogeneous appearances after manufacture thereof.

The control composition T3 has a non-homogeneous (two-phase) appearance with the presence of deposits at the bottom of the tank after manufacture thereof. Consequently, the use of gilsonite for hardening the bitumens is not recommended due to the non-homogeneous appearance of the composition obtained. The mechanical property tests were therefore not able to be performed on this control composition T3.

### II—Measurements of the Mechanical Properties of the Compositions According to the Invention, of the Bitumen Bases and of the Control Compositions:

The properties in terms of penetrability, softening point, Fraaas point and modulus G* at a frequency of 10 Hz and at temperatures of 15° C. and 60° C., respectively, were measured for compositions C1 to C10, the bitumen bases B1 to B6 and the control compositions T1 to T3.

The properties of compositions C1 to C10 and the properties of the bitumen bases B1 to B6 and of the control compositions T1 to T3 are summarized in tables 4A and 4B below:

TABLE 4A
Mechanical properties of compositions C1 to C10

| | Composition | | | | | | | | | |
|---|---|---|---|---|---|---|---|---|---|---|
| | C1 | C2 | C3 | C4 | C5 | C6 | C7 | C8 | C9 | C10 |
| Penetrability | 30 | 30 | 28 | 16 | 26 | 19 | 86 | 62 | 87 | 64 |
| ( 1/10 mm) | | | | | | | | | | |
| RBSP (° C.) | 58.2 | 58.6 | 55.6 | 63.6 | 58.6 | 64.2 | 47.2 | 50.6 | 46.6 | 50.2 |
| G* (MPa) | 28.2 | 28.3 | 69 | 96 | 76 | 105 | 8.0 | 12.4 | 7.2 | 9.7 |
| (15° C., 10 Hz) | | | | | | | | | | |
| G* (Pa) | 53 800 | 57 800 | nd | nd | nd | nd | nd | nd | nd | nd |
| (60° C., 10 Hz) | | | | | | | | | | |

nd: property not determined

TABLE 4B
Mechanical properties of the bitumen bases B1 to B6 and of the controls T1 to T3

| | Composition | | | | | | | |
|---|---|---|---|---|---|---|---|---|
| | B1 | B2 | B3 | B4 | B5 | B6 | T1 | T2 |
| Penetrability | 50 | 40 | 125 | 89 | 25 | 16 | 30 | 42 |
| ( 1/10 mm) | | | | | | | | |
| RBSP (° C.) | 51.1 | 51.6 | 42 | 45.6 | 113 | 65.4 | 58.2 | 54.6 |
| G* (MPa) | 21.4 | 54 | 5.7 | 9.1 | 12.2 | 47 | 39.8 | 19.1 |
| (15° C., 10 Hz) | | | | | | | | |
| G* (Pa) | 24 000 | nd | nd | nd | nd | nd | nd | 27 500 |
| (60° C., 10 Hz) | | | | | | | | |

nd: property not determined

Mechanical Properties of Compositions C1 to C10, of the Bitumen Bases B1 to B6 and of the Controls T1 to T3 after Aging

It is observed that the addition of a pitch according to the invention to a bitumen base of softer grade such as Azalt® 50/70 or Azalt® 35/50 leads to hardening of this base, which is reflected especially by a lowering of the penetrability and an increase in the RBSP (compositions C1, C2, C3, C5):
i) from 50 to 30 1/10 mm and from 51.1 to 58.2° C. or 58.6° C. for Azalt® 50/70 in the presence of 12% of pitch,
ii) from about 40 to 28 1/10 mm and from about 51.6 to 55.6° C. for Azalt® 35/50 in the presence of 5% of pitch,
iii) from about 40 to 26 1/10 mm and from about 51.6 to 58.6° C. for Azalt® 35/50 in the presence of 10% of pitch,
   which makes it possible to formulate a composition that meets the specifications in terms of penetrability and RBSP to a composition of 20/30 grade, starting with a 50/70 or 35/50 grade.

It is observed that the addition of a pitch according to the invention to a bitumen base of softer grade such as Azalt® 35/50 leads to hardening of this base, which is reflected especially by a lowering of the penetrability and/or an increase in the RBSP (compositions C4 and C6):
i) from about 40 to 16 1/10 mm and from about 51.6 to 63.6° C. for Azalt® 35/50 in the presence of 15% of pitch (PIT3),
ii) from about 40 to 19 1/10 mm and from about 51.6 to 64.2° C. for Azalt® 35/50 in the presence of 20% of (PIT2) pitch,
   which makes it possible to formulate a composition that meets the specifications in terms of penetrability and RBSP to a composition of 10/20 grade, starting with a 35/50 grade.

It is observed that the addition of a pitch according to the invention to a bitumen base of softer grade such as Azalt® 50/70 or Azalt® 35/50 leads to a significant increase in the G* modulus of the composition:

i) for a bitumen of 50/70 grade, its modulus passes from 21.4 MPa to a modulus above 28 MPa with the addition of 12% of pitch according to the invention,
ii) for a bitumen of 35/50 grade, its modulus passes from 54 to a modulus of between 69 and 105 MPa as a function of the added amount of pitch according to the invention.

Comparatively, it is observed that the addition of Modulotal® 10/20 to a bitumen base of softer grade such as Azalt® 50/70 leads to hardening of this base, which is reflected especially by a lowering of the penetrability and an increase in the RBSP (composition T1):
i) from 50 to 30 1/10 mm and from 51.1 to 58.2° C. for Azalt® 50/70 in the presence of 39% of Modulotal® 10/20,
   which makes it possible to formulate a composition that meets the specifications in terms of penetrability and RBSP to a composition of 20/30 grade, starting with a 50/70 grade.

As regards the modulus, the addition of Modulotal® to a bitumen base of softer grade such as Azalt® 50/70 leads to a significant increase in the G* modulus of the composition:

i) for a bitumen of 50/70 grade, its modulus passes from 21.4 MPa to a modulus above 40 MPa with the addition of 39% of Modulotal.

However, at equivalent penetrability, i.e. in order to obtain a composition of 20/30 grade from a 50/70 grade, it is necessary to use at least three times more hard bitumen Modulotal® 10/20 than pitch, which represents greater complexity in logistic terms for the hard bitumen.

Comparatively, it is observed that the addition of Stelox® 110/30 to a bitumen base of softer grade such as Azalt® 50/70 leads to hardening of this base, which is reflected especially by a lowering of the penetrability and an increase in the RBSP (composition T2):
i) from 50 to 42 1/10 mm and from 51.1 to 54.6° C. for Azalt® 50/70 in the presence of 12% of Stelox® 110/30,
   which makes it possible to formulate a composition that meets the specifications in terms of penetrability and RBSP to a composition of 35/50 grade, starting with a 50/70 grade.

However, at an equivalent content of Stelox® and of pitch, i.e. with 12% of Stelox® in the control composition T2 and 12% of pitch in composition C1, a bitumen of 50/70 grade gives a composition of 35/50 grade using Stelox®, whereas by using only pitch, starting with a bitumen of 50/70 grade, a composition of 20/30 grade is obtained.

It is also observed that the addition of 12% of Stelox® to a bitumen of 50/70 grade does not make it possible to improve the modulus of this bitumen, but, quite to the contrary, lowers its modulus, since it goes from 21.4 MPa to 19.1 MPa, in contrast with the addition of pitch to a bitumen of 50/70 grade.

Consequently, these results demonstrate that, with an equivalent content of Stelox® and of pitch, a bitumen comprising 12% of pitch has a harder grade and also a higher modulus than a bitumen comprising 12% of Stelox®.

It is also observed that the addition of a pitch according to the invention to a bitumen base B3 of softer grade leads to hardening of this base, which is reflected especially by a lowering of the penetrability and/or an increase in the RBSP:
i) from 125 to 86 1/10 mm and from 42 to 47.2° C. for the bitumen base B3 in the presence of 5% of pitch PIT2 (composition C7),
ii) from 125 to 87 1/10 mm and from 42 to 46.6° C. for the bitumen base B3 in the presence of 3% of pitch PIT3 (composition C9),
   which makes it possible to formulate a composition that meets the specifications in terms of penetrability to a composition with a penetrability of less than 90 1/10 mm, and which meets the specifications of the AC10 grade.

It is also observed that the addition of a pitch according to the invention to a bitumen base B4 of softer grade leads to hardening of this base, which is reflected especially by a lowering of the penetrability and/or an increase in the RBSP:
i) from 89 to 62 1/10 mm and from 45.6 to 50.6° C. for the bitumen base B4 in the presence of 5% of pitch PIT2 (composition C8),
ii) from 89 to 64 1/10 mm and from 45.6 to 50.2° C. for the bitumen base B4 in the presence of 3% of pitch PIT3 (composition C1 0),
   which makes it possible to formulate a composition that meets the specifications in terms of penetrability to a composition with a penetrability of less than 70 1/10 mm, and which meets the specifications of the AC20 grade.

It is observed that the addition of a pitch according to the invention to a bitumen base of softer grade such as the bitumen bases B3 or B4 leads to a significant increase in the G* modulus of the composition:
i) for the bitumen base B3, its modulus passes from 5.7 to a modulus of between 7.2 and 8 MPa as a function of the added amount of pitch according to the invention,
ii) for the bitumen base B4, its modulus passes from 9 to a modulus of between 9.7 and 12.4 MPa as a function of the added amount of pitch according to the invention.

Consequently, the addition of pitch according to the invention to a bitumen base makes it possible simultaneously to obtain a bitumen base of harder grade and also to obtain a bitumen base which has a high modulus, allowing it to be used for the manufacture of high-modulus surfacing mixes.

III—Preparation of Bituminous Surfacing Mixes and Measurement of their Mechanical Properties:

A bituminous surfacing mix is characterized as a high-modulus bituminous surfacing mix, also known as EME according to the standard NF EN 13108-1 if it has at least one complex stiffness modulus of greater than 14 000 MPa, the measurement being taken at 15° C. and at a frequency of 10 Hz according to the standard NF EN 12697-26.

Two bituminous surfacing mixes (E1 and E2) are obtained, respectively, from the bitumen base B1 and from composition C2 according to the invention and from aggregates having the granular fraction described in table 5:

TABLE 5
Particle size composition

| | Fraction (mm) | | | | |
|---|---|---|---|---|---|
| | 0/2 | 2/6 | 6/10 | 10/14 | Filler |
| Weight (%) | 31 | 18 | 20 | 29 | 2 |

The bituminous surfacing mixes are prepared in the following manner:
The aggregates are brought to a temperature of 165° C. over a period of about 8 hours.
The bituminous composition is heated to 165° C. and then poured onto the preheated aggregates, and the mixture thus obtained is then blended for about 180 seconds at 165° C.

The bituminous surfacing mixes thus obtained have a bituminous composition content of 5.1% by mass relative to the total mass of the surfacing mixes.

The bituminous surfacing mixes E1 and E2 are obtained according to the method described above and comprise, respectively, 5.1% by mass of bitumen base B1 and of composition C2 according to the invention relative to the total mass of the surfacing mixes.

The complex stiffness moduli of the bituminous surfacing mixes E1 and E2 are collated in table 6 below.

TABLE 6
Complex stiffness modulus of the bituminous
surfacing mixes E1 and E2

| | E1 | E2 |
|---|---|---|
| Complex modulus at | 11 493 | 14 608 |
| 15° C. and at 10 Hz | | |
| (MPa) | | |

The bituminous surfacing mixes E2 obtained from composition C2 according to the invention have a complex modulus of 14 608 MPa, unlike the bituminous surfacing mixes E1 obtained from the bitumen base of 50/70 grade, the complex modulus of which is 11 493 MPa.

Consequently, the bituminous surfacing mixes E2 with a modulus value of greater than 14 000 Pa may be used as high-modulus bituminous surfacing mixes, unlike the bituminous surfacing mixes E1.

### IV—Preparation of the Various Cores of Bituminous Composition Pellets

### 4.1 Preparation of the Supplemented Bituminous Composition

The supplemented bituminous composition C2′ is prepared from composition C2 prepared previously and from 1,10-decanedioic acid, denoted Additive A1. The amounts as mass percentages used for the preparation of the supplemented bituminous composition C2′ are shown in table 7 below.

TABLE 7

| Supplemented | |
|---|---|
| composition | C2′ |
| Composition C2 | 98.5% |
| Additive A1 | 1.5% |

The supplemented bituminous composition C2′ is prepared in the following manner:

Composition C2 is placed in a reactor maintained a 160° C. with stirring at 300 rpm for two hours. Additive A1 is then introduced into the reactor. The contents of the reactor are maintained at 160° C. with stirring at 300 rpm for 1 hour.

The cores of pellets G₂ are prepared from the supplemented bituminous composition C2′ according to one of the following protocols.

### 4.2 General Method for Preparing the Cores Made of Bituminous Composition G₂ of the Pellets According to the Invention

The bituminous composition base C2′ is heated at 170° C. for two hours in an oven and then poured into a silicone mold having different holes of spherical shape, so as to form the bituminous composition cores. After having observed the solidification of the bituminous composition in the mold, the surplus is leveled off using a blade heated with a Bunsen burner. After 30 minutes, the solid bituminous composition in the form of uncoated pellets is demolded and stored in a tray coated with silicone paper.

### 4.3 General Method for Preparing the Cores Made of Bituminous Composition G₂ of the Pellets According to the Invention Via an Industrial Process

For the implementation of this method, use may be made of a device and of a process as described in great detail in patent U.S. Pat. No. 4,279,579. Various models of this device are commercially available from the company Sandvik under the trade name Rotoform.

Pellets G₂ of bituminous composition may also be obtained from the supplemented bituminous composition C2′ poured into the tank of such a device and maintained at a temperature of between 130 and 270° C.

One or more injection nozzles allow the transfer of the supplemented bituminous composition C2′ inside the pelletizing twin drum including an external rotating drum, the two drums being equipped with slits, nozzles and orifices allowing the pelletizing of drops of bituminous composition through the first stationary drum and the orifices between 2 and 10 mm in diameter of the external rotating drum. The drops of bituminous composition are deposited on the upper face of a horizontal conveyor belt driven by rollers.

### V—General Method for Preparing Pellets of Solid Bituminous Composition According to the Invention Comprising a Coating Layer Composed of at Least One Anticaking Compound

The pellets of supplemented bituminous composition obtained according to methods 4.2 and 4.3 are left at ambient temperature for 10 to 15 minutes. The pellets thus formed are covered on their surface with an anticaking compound and then screened to remove the excess anticaking compound.

The pellets G₂′ are prepared from the pellets G₂ obtained previously and according to the method described above using, as anticaking compound, fumed silica commercially available under the reference Aerosil® 200.

The mass percentage of the coating for the pellets G₂′ is about 1% by mass relative to the total mass of bitumen of the pellets.

It is noted that the pellets obtained have the advantage of being easily transportable and have good resistance to storage.

1-20. (canceled)

21. A bituminous composition which is in solid form under cold conditions and in divided form, characterized in that the composition comprises:
a) at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, and
b) at least one bitumen base.

22. The composition as claimed in claim 21, wherein the pitch is an oxidized pitch.

23. The composition as claimed in claim 21, wherein the pitch is present in an amount ranging from 2% to 30% by mass relative to the total mass of the composition.

24. The bituminous composition as claimed in claim 21, which is solid under cold conditions and in divided form, and also comprises at least one chemical additive chosen from an organic compound, a paraffin, a polyphosphoric acid, and mixtures thereof.

25. The bituminous composition as claimed in claim 24, comprising from 0.1% to 5% by mass of said chemical additive relative to the total mass of said bitumen base.

26. The bituminous composition as claimed in claim 25, comprising from 0.5% to 4% by mass of said chemical additive, relative to the total mass of said bitumen base.

27. The bituminous composition as claimed in claim 26, comprising from 0.5% to 2.5% by mass of said chemical additive, relative to the total mass of said bitumen base.

28. The bituminous composition as claimed in claim 24, wherein the chemical additive is an organic compound which has a molar mass of less than or equal to 2000 g·mol⁻¹.

29. The bituminous composition as claimed in claim 24, in the form of blocks or pellets.

30. A process for manufacturing a bitumen composition as claimed in claim 21, said process comprising the following steps:
i) heating the bitumen base b) to a temperature ranging from 140 to 180° C.,
ii) introducing pitch a) into the bitumen base b),
iii) stirring the mixture at a temperature ranging from 140 to 180° C. until a homogeneous mixture is obtained.

31. The process as claimed in claim 28, wherein the pitch is introduced in the form of pellets.

32. A kit that may be used for the manufacture of a bituminous composition as claimed in claim 21, comprising at least:
a bitumen base which is solid under cold conditions and in divided form,
a capsule comprising at least one pitch with a penetrability at 25° C. ranging from 0 to 20 1/10 mm and a ring and ball softening point (RBSP) ranging from 115° C. to 175° C., it being understood that the penetrability is measured according to the standard EN 1426 and that the RBSP is measured according to the standard EN 1427, in the form of pellets.

33. The kit as claimed in claim 32, wherein the bitumen base which is solid under cold conditions and in divided form is in block form.

34. The kit as claimed in claim 32, wherein the bitumen base which is solid under cold conditions and in divided form comprises, on one of its faces, a cavity for housing all or part of the capsule.

35. The kit as claimed in claim 34, wherein the capsule is removably housed entirely or partially in said cavity.

36. The process as claimed in claim 30, further comprising, after step iii):
iv) the mixing of the bituminous composition obtained in step iii) and of at least one chemical additive chosen from an organic compound, a paraffin, a polyphosphoric acid, and mixtures thereof, to form a supplemented bituminous composition,
v) the forming of the supplemented bituminous composition in the form of a block or pellets.

37. The bituminous composition as claimed in claim 21, which has a complex modulus G*, measured at 15° C. according to standard EN 14770, superior or equal to the complex modulus G* of the bitumen base.
